(19) United States
(12) Patent Application Publication
(10) Pub. No.: US 2010/0208655 A1
(43) Pub. Date: Aug. 19, 2010

(54) METHOD OF TRANSMITTING PACKET FOR REDUCING HEADER OVERHEAD

(76) Inventors: Jeong Ki Kim, Gyeonggi-do (KR); Yong Ho Kim, Gyeonggi-do (KR); Ki Seon Ryu, Gyeonggi-do (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/670,769

(22) PCT Filed: Jul. 25, 2008
(86) PCT No.: PCT/KR08/04364

§ 371 Date: Jan. 26, 2010

(30) Foreign Application Priority Data
Jul. 27, 2007 (KR) 10-2007-0076069
Jan. 22, 2008 (KR) 10-2008-0006670

(51) Int. Cl. H04W 4/00; H04L 12/66

(52) U.S. Cl. 370/328; 370/352

(57) ABSTRACT

A method of transmitting a packet for reducing header overhead is disclosed. That is, a detailed method of transmitting a packet including a compressed header by omitting a header including the same information as a header of a packet which is previously transmitted or omitting information overlapping with the header of the packet which is previously transmitted is provided.

### TECHNICAL FIELD

The present invention relates to a method of transmitting a packet in a wideband wireless access system, and more particularly, to a method of transmitting a packet, which is capable of reducing overhead of a header inserted into the packet when the packet is transmitted/received between a base station and a mobile station.

### BACKGROUND ART

Hereinafter, a method of transmitting a packet, which is capable of reducing header overhead in a wideband wireless access system, will be described. In particular, a method of omitting or compressing a header in a specific situation and transmitting a packet in order to reduce header overhead of mobile stations using a Voice over Internet Protocol (VoIP) service will be described. First, VoIP traffic will be briefly described. The packet transmitting method according to the present invention is not limited to the transmission of the VoIP packet which will be described below.

The VoIP traffic is characterized in that it is generated with a fixed size having a fixed period in a VoIP codec. VoIP communication may be divided into a talk-spurt period in which there is active conversation between users and a silence period in which a user listens to a speaker without speaking. The silence period occupies more than 50% of a general call session.

Accordingly, various audio codecs are used for allocating different amounts of bandwidths to the talk-spurt period and the silence period. Among them, as a representative example, there is an adaptive multi-rate (AMR) used in global system for mobile communication (GSM) and universal mobile telecommunications system (UMTS).

Since audio data is not generated in the silence period, a resource may be wasted if a bandwidth is allocated to the silence period. In order to solve this problem, the VoIP supports silence suppression. According to the silence suppression, a vocoder for generating the VoIP traffic does not generate the traffic during the silence period and periodically generates conform noise in order to inform a counterpart that the call is continuously maintained. For example, the vocoder using the AMR codec generates a packet having a fixed size at an interval of 20 ms in the talk-spurt period and generates conform noise with an interval of 160 ms in the silence period.

The wideband wireless access system (for example, IEEE 802.16e) provides a new scheduling method such as an Extended real-time Polling service (Extended rtPS) for the VoIP traffic which supports the silence suppression. According to this method, the base station periodically allocates an uplink bandwidth used for bandwidth request or data transmission and does not change the size of the uplink (UL) allocation until a request for the change of the bandwidth is received from the mobile station. If the mobile station requests the change of the bandwidth and a bandwidth request size is set to 0, the base station allocates only a unicast bandwidth request (BR) opportunity for transmitting a BR header or does not allocate the bandwidth.

Generally, in order to allocate the resource to the traffic having a predetermined period and having a fixed size, such as the VoIP, the base station may use a method of fixedly allocating a specified region to a specific mobile station. That is, a region having a predetermined size is initially allocated to a mobile station for supporting the VoIP service and the mobile station is informed of information on the allocated region via an UL-MAP which is initially transmitted. Period information of the regions which are subsequently allocated may be also included in the UP-MAP which is initially transmitted.

Thereafter, in a next period, the base station may continuously allocate the region to the mobile station without informing the mobile station of the region which is initially informed via the UL-MAP. Then, the mobile station transmits the VoIP packet to the allocated region using the information on the region which is initially allocated in the map and transmits the VoIP region to the same region from the next period using the period information.

If allocation information overlapping with the region which is initially allocated to the mobile station for the VoIP appears in an UL-MAP message which is subsequently transmitted, the VoIP packet is not transmitted to the region which is initially allocated. If the mobile station already has the allocation information for the VoIP connection when receiving an UL-MAP IE corresponding to the mobile station for the VoIP allocation or a UL-MAP IE for changing the position for the VoIP allocation, the VoIP packet is not transmitted to the region which is previously allocated and the VoIP packet is transmitted to a region which is newly allocated.

A method of persistently allocating a resource is called a persistent resource allocation method.

Hereinafter, this embodiment will be described in detail with reference to the accompanying drawings.

FIGS. 1 and 2 are views showing examples of a method of, at a base station, periodically allocating a resource to a mobile station for a VoIP service.

In more detail, FIG. 1 shows an example of a case where the length of a frame is 5 ms in consideration of the VoIP service and the period of the frame which is allocated to the mobile station in order to transmit the VoIP packet is set to four frames. The period of the frame which is allocated to the mobile station in order to transmit the VoIP packet varies according to the characteristics of the service. In particular, even in the same VoIP service, the period of the frame which is allocated in order to transmit the VoIP packet may vary according to parameters such as the system characteristics (e.g., the system characteristics according to the length of the frame) and the status of the VoIP service (e.g., the talk-spurt period or the silence period).

In the example of FIG. 1, the base station informs the mobile station of the information on the allocated region for transmitting the VoIP packet via an UL-MAP at Frame 0 which is an initial frame, and allocates only a region for transmitting the VoIP packet without informing the mobile station of the information on the allocated region via the UL-MAP at Frame 4 and Frame 8 corresponding to next periods.

At this time, the period of the frame allocated for transmitting the VoIP packet is four frames (that is, 20 ms). That is, the mobile station may store the information on the allocated region included in the UL-MAP received at Frame 0 and transmit the VoIP packet via the region at Frames 4 and 8 corresponding to the allocation periods even when the UL-MAP is not received.

Next, the example shown in FIG. 2 will be described.

In the example of FIG. 2, the base station may allocate a region P1 for transmitting a VoIP packet of a specific mobile station at Frame 0 and transmit information on the allocated region via a UL-MAP.

Thereafter, in FIG. 2, at Frame 4, the base station allocates a resource P2 for other mobile stations to a region P1, which is allocated for the VoIP packet at Frame 0, and allocates a resource for the mobile station, which transmits the VoIP packet at Frame 0, to another region P1. The mobile station, which transmits the VoIP packet at Frame 0, may check that the resource is allocated to the region different from the region, which is initially allocated, at Frame 4, transmit the VoIP packet to the region P1 which is newly allocated instead of the region P2 which is initially allocated, and update parameters related thereto.

Alternatively, if a new resource is allocated to the region P1 for the mobile station at Frame 4, it may be determined that the region which is previously allocated is allocated for the transmission of another packet and the VoIP packet may not be transmitted to the region which is previously allocated.

By using the above-described resource allocation method, it is possible to reduce the overhead due to the transmission of the UL resource allocation information to the mobile station for supporting the VoIP service in each frame.

Instead of the above-described resource allocation method for the VoIP service, as another method of reducing the overhead due to the transmission of the resource allocation information, a method (group resource allocation method) of configuring mobile stations having the same attribute to a group and allocating a small number of resources to the mobile stations belonging to the group may be used.

Now, the structure of the packet which is transmitted in FIG. 1 and FIG. 2 will be briefly described.

FIG. 3 is a view showing an example of a medium access control protocol data unit (MAC PDU) defined in a wireless MAN mobile communication system based on the IEEE 802.16 system, which is generally used.

Generally, in a link layer (or a MAC layer) and a physical layer, which are below a second layer, protocols of the systems such as LAN, wireless LAN, 3GPP/3GPP2, and Wireless MAN and header formats of the MAC PDU thereof are differently defined. The MAC header may include MAC addresses or link addresses of nodes for delivering data between the nodes of the link layer and include a header error check and link layer control information.

Referring to FIG. 3, the MAC PDU 300 is started by a MAC header 301 having a predetermined length. The generic MAC header 301 may be located in front of a payload 302 of the MAC PDU as shown in FIG. 3. If the header 301 is present, the payload 302 may be constituted by a subheader, a MAC SDU and a fragment. The length of the payload information may be changed so as to represent a variable byte. Accordingly, a MAC sub layer may transmit various traffic types of an upper layer without recognizing the format of a message or a bit pattern. The MAC PDU 300 may include a cyclic redundancy check (CRC) 303.

FIG. 4 is a view showing an example of the MAC header used in the wireless MAN mobile communication system based on the IEEE 802.16 system which is generally used.

Referring to FIG. 4, the generic MAC header and six subheaders may be used in the MAC PDU. The PDU-based subheaders are inserted next to the generic MAC header. The fields included in the generic MAC header will be described in detail.

A HT field indicates a header type and indicates whether the MAC PDU is the generic MAC header including the payload next to the header or a signaling header for controlling a band request. An EC field indicates encryption control and indicates whether the payload is encrypted. A Type field indicates whether or not the subheader located next to the header is present or the type of the subheader. An ESF field indicates whether or not an extended subheader located next to the header is present.

A CI field indicates whether or not the CRC is located next to the payload. An EKS field indicates an encryption key sequence number used for encryption if the payload is encrypted. A LEN field indicates the length of the MAC PDU. A connection identifier (CID) indicates the connection identifier for delivering the MAC PDU. The connection is used as the identifier of the MAC layer for delivering data and a message between the base station and the mobile station, and the CID performs a function for identifying a specific mobile station or a specific service between the base station and the mobile station. In FIG. 4, a numeral in parentheses located next to each of the fields indicates the bit number of each of the fields.

As shown in FIGS. 1 and 2, the base station may fixedly and persistently allocate the resource to one VoIP connection due to the VoIP traffic characteristics. The VoIP packets which are periodically transmitted to the region allocated initially are packets for one VoIP connection and may be transmitted in a state in which all or a portion of the information included in the fields of the header structure shown in FIG. 4 has the same MAC header. Like the above-described example of the transmission of the VoIP packet, the repetitive transmission of the header having the same information as the header included in the packet which is previously transmitted or the header having partially overlapped information increases the header overhead and thus is not efficient in view of the resource operation.

### DISCLOSURE

### Technical Problem

An object of the present invention devised to solve the problem lies on a method of transmitting a packet including a compressed header by omitting a header including the same information as a header of a packet which is previously transmitted or omitting information overlapping with the header of the packet which is previously transmitted, such that header overhead is reduced when transmitting the packet.

Another object of the present invention devised to solve the problem lies on a detailed method of compressing or omitting the header when transmitting a VoIP packet, in which is further efficient in a method of transmitting a VoIP packet is significantly influenced by the header overhead.

A further object of the present invention devised to solve the problem lies on a method of coping with the case where the header should be updated in a base station or a mobile station in a specific situation even when header compression or omission is supported or the case where the transmission of a packet fails.

### Technical Solution

The object of the present invention can be achieved by providing a method of transmitting a packet, the method including: transmitting a first packet including a first header; and transmitting a second packet after the first packet is transmitted, the transmitting of the second packet is performed as, if a second header of the second packet includes the same information as information included in the first header, transmitting the second packet in a state of omitting the second header; or transmitting the second packet in a state of compressing the second header by omitting the same information of the second header as the information included in the first header. Accordingly, it is possible to reduce header overhead.

At this time, in a Voice over Internet Protocol (VoIP) packet which is significantly influenced by header overhead, transmission packets including the first packet and the second packet may be the VoIP packets but are not limited thereto. At this time, resources are allocated to the VoIP packets by a persistent resource allocation method or a group resource allocation method.

In order to support the header omission and/or compression, the first header may include an indicator (e.g., a next header indicator (NHI)) indicating whether or not the next header is omitted, or whether or not the header is compressed.

In a preferred embodiment of the present invention, a detailed method for solving the header overhead by the header omission or the header compression and updating the header in a specific situation is provided.

In more detail, in a preferred embodiment of the present invention, the method may further include transmitting a header update request message, receiving a header update response message for the header update request message, and transmitting the updated header, if the update of header information of a subsequent packet next to the specific packet is required after a specific packet is transmitted. After the header update is informed, the updated header information may be transmitted to the same region as the subsequent packet or a region different from the subsequent packet.

The method may further include transmitting a third packet including an updated third header after the header update is informed, or the header information which requires the update may be included in the header update request message.

Unlike the above-described embodiment, the method may further include transmitting a channel quality indicator channel (CQICH) codeword which is previously allocated for the update of the header, and transmitting a third packet including a third header including header information which requires the update, if the update of header information of the subsequent packet subsequent to the specific packet is required after a specific packet is transmitted.

Unlike the above-described embodiment, the method may further include transmitting a MAP information element (MAP IE) for informing the event, and performing any one of the update of the header information of the subsequent packet, the header omission or the header compression (e.g., uplink/downlink MAC header optimization IE), if an event corresponding to any one of the update of the header information of the subsequent packet subsequent to the specific packet, header omission or header compression occurred a specific packet is transmitted.

In a preferred embodiment of the present invention, as described above, it is possible to solve the header overhead by the header omission or the header compression and increase a reception probability by interrupting the header omission or compression and including the generic header if the reception of the packet fails by a predetermined number of times.

That is, the method may further include retransmitting the second packet without omitting or compressing the second header if a NACK is received from a receiver with respect to the transmission of the second packet by a predetermined number of times.

The method may further include, at a mobile station, negotiating with a base station whether at least one of a header omission function and a header compression function is supported, and, at the mobile station, negotiating with the base station whether at least one of the header omission function and the header compression function is activated, before the above-described steps.

In the embodiment using the header compression, if the second header is a compressed header, the second header may include a fixed part and a variable part, and the variable part may include information which varies according to a type field of the second header. The variable part may include information which requires the update of the header when the second packet is transmitted.

In the present embodiment, the information which is omitted as the same information of the second header as the information included in the first header may include at least one of a connection ID (CID) and the length of the packet.

In another aspect of the present invention, provided herein is a method of transmitting an uplink packet of a mobile station, the method including: (a) receiving first indication information indicating header omission or header compression from a base station if a header omission event or a header compression event is generated in the mobile station or the base station; and (b) omitting or compressing a second header of a second packet subsequent to the reception of the first indication information according to the first indication information and transmitting the second packet to the base station. Here, the “header omission event” indicates the case where a packet including the same header as the header of a packet which is previously transmitted needs to be transmitted and the “header compression event” indicates the case where a header including the same information included in the header of a packet which is previously transmitted needs to be transmitted. Accordingly, the omission or the compression of the second header is performed with respect to information overlapping with a first header of a first packet which is transmitted before the second packet is transmitted. In this case, it is assumed that the mobile station provides the header omission function and/or the header compression function. That is, in the present embodiment, a detailed method of exchanging information between the base station and the mobile station in order to reduce header overhead by the header omission or the header compression is provided.

Preferably, in the present embodiment, the method may further include, if the header update event is generated in the base station or the mobile station, (c) receiving second indication information indicating the header update from the base station, and (d) updating a third header of a third packet subsequent to the reception of the second indication information according to the second indication information and transmitting the third header to the base station. Accordingly, it is possible to properly cope with the case where the header information is changed.

The method may further include, if the header omission event, the header compression event or the header update event are generated in the mobile station in the step (a) or (c), reporting the generation of the event in the mobile station to the base station before the step (a) or (c).

Here, information indicating the header omission or the header compression and information indicating the header update may be received using at least one of a MAP information element (IE), a generic MAC header, a MAC signaling header, an extended subheader and a MAC management message. In the reporting of the generation of the event, information on the generation of the event is reported using at least one of an MAP information element (IE), a generic MAC header, a MAC signaling header, an extended subheader, a specific channel quality indicator channel (CQICH) codeword and a MAC management message.

In a preferred embodiment of the present invention, the MAP IE may includes information indicating whether or not the header of the second packet or the third packet transmitted just after the MAP IE is received is omitted or compressed, and information indicating whether or not a header format of a fourth packet next to the second packet or the third packet is equal to that of the second packet or the third packet.

The MAP EI may represent whether or not the header of the second packet or the third packet transmitted just after the MAP EI is received is omitted, compressed or updated (e.g., the uplink/downlink MAC header optimization IE).

That is, in another aspect of the present invention, provided herein is method of transmitting a downlink packet of a base station, the method including: (a) omitting or compressing a second header of a second packet subsequent to the generation of a header omission event or a header compression event and transmitting the second packet, if the header omission event or the header compression event is generated in the base station or a mobile station, wherein the omission or the compression of the second header is performed with respect to information overlapping with a first header of a first packet which is transmitted before the second packet is transmitted.

In the present embodiment, the method may further include (b), if a header update event is generated in the base station or the mobile station, updating a third header of a third packet subsequent to the generation of the header update event and transmitting the third packet to the mobile station.

The method may further include, if the header omission event, the header compression event or the header update event is generated in the mobile station in the step (a) or (b), at the base station, receiving information on the generation of the event from the mobile station. At this time, in the receiving of the information on the generation of the event, the information on the generation of the event may be received using at least one of an MAP information element (IE), a generic MAC header, a MAC signaling header, an extended subheader, a specific channel quality indicator channel (CQICH) codeword and a MAC management message.

The MAP IE may include information indicating whether or not the header of the second packet or the third packet transmitted just after the MAP IE is received is omitted or compressed; and information indicating whether or not a header format of a fourth packet next to the second packet or the third packet is equal to that of the second packet or the third packet. The MAP IE may represent whether or not the header of the second packet or the third packet transmitted just after the MAP IE is received is omitted, compressed or updated.

### ADVANTAGEOUS EFFECTS

As described above, according to the embodiments of the present invention, since a packet including a compressed header is transmitted by omitting a header including the same information as a header of a packet which is previously transmitted or information overlapping with the header of the packet which is previously transmitted, it is possible to solve header overhead.

In particular, the packet transmitting method is further efficient in a VoIP packet transmitting method which is significantly influenced by the header overhead. In a detailed embodiment of the present invention, for header omission or compression at the time of the transmission of the VoIP packet, a detailed method of exchanging information between a base station and a mobile station is provided such that the header overhead is efficiently reduced.

Even when the header compression or the omission is supported as described above, a detailed method which copes with the case where a header is updated in the base station or the mobile station even in a specific situation or the case where packet transmission fails is provided so as to actively cope with various situations.

### DESCRIPTION OF DRAWINGS

The accompanying drawings, which are included to provide a further understanding of the invention, illustrate embodiments of the invention and together with the description serve to explain the principle of the invention.

In the drawings:

FIGS. 1 and 2 are views showing examples of a method of, at a base station, periodically allocating a resource to a mobile station for a VoIP service.

FIG. 3 is a view showing an example of a medium access control protocol data unit (MAC PDU) defined in a wireless MAN mobile communication system based on the IEEE 802.16 system which is generally used.

FIG. 4 is a view showing an example of a MAC header used in the wireless MAN mobile communication system based on the IEEE 802.16 system which is generally used.

FIG. 5 is a view showing an example of a generic MAC header for supporting a method of transmitting a packet in a state of omitting a MAC header, according to an embodiment of the present invention.

FIG. 6 is a view showing a method of transmitting a packet in a state of omitting a MAC header, according to an embodiment of the present invention.

FIG. 7 is a view showing a method of transmitting a packet in a state of omitting a MAC header, according to another embodiment of the present invention.

FIG. 8 is a view showing a method of transmitting a packet in a state of omitting a MAC header, according to another embodiment of the present invention.

FIG. 9 is a view showing a method of transmitting a retransmission packet including a header when the reception of a packet fails, according to an embodiment of the present invention.

FIGS. 10 and 11 are views showing a method of transmitting a retransmission packet including a header when the reception of a packet fails by a predetermined number of times, according to an embodiment of the present invention.

FIG. 12 is a view showing a method of transmitting a next packet including a generic header when a next packet transmission period is reached while a NACK is received due to the failure of the packet reception, according to another embodiment of the present invention.

FIG. 13 is a view showing an example of a MAC signaling header which may be used for updating the header, according to an embodiment of the present invention.

FIG. 14 is a view showing a method of omitting a header using an MAP IE when a downlink packet is transmitted, according to an embodiment of the present invention.

FIG. 15 is a view showing a method of omitting and updating a downlink header using an MAP IE, according to another embodiment of the present invention.

FIG. 16 is a view showing a method of omitting and updating a downlink header using an MAP IE, according to another embodiment of the present invention.

FIG. 17 is a view showing a method of omitting and updating a downlink header using a specific CQICH codword, according to another embodiment of the present invention.

FIG. 18 is a view showing a method of omitting a header using an UL_MAP IE when an uplink packet is transmitted, according to an embodiment of the present invention.

FIG. 19 is a view showing a method of omitting a header using an UL_MAP IE when an uplink packet is transmitted, according to another embodiment of the present invention.

FIG. 20 is a view showing a method of omitting a header using a specific CQICH codeword when an uplink packet is transmitted, according to another embodiment of the present invention.

FIG. 21 is a view showing a method of transmitting an uplink packet in a state in which a header is omitted, by informing whether or not the header is updated using an UL_MAP IE, according to another embodiment of the present invention.

FIG. 22 is a view showing a method of transmitting an uplink packet in a state of omitting a header, by informing whether or not the header is updated using a header update request message, according to another embodiment of the present invention.

FIG. 23 is a view showing a method of transmitting an uplink packet in a state of omitting a header, by informing whether or not the header is updated using a specific CQICH codeword, according to another embodiment of the present invention.

FIG. 24 is a view showing an example of a compressed MAC header according to an embodiment of the present invention.

FIG. 25 is a view showing examples of fields which may be included in a variable part of a compressed MAC header according to an embodiment of the present invention.

FIG. 26 is a view showing an example of a method of transmitting a VoIP packet using a compressed header according to an embodiment of the present invention.

FIG. 27 is a view showing a method of transmitting a packet using a compressed header according to another embodiment of the present invention.

FIG. 28 is a view showing a method of transmitting a packet using a compressed header according to another embodiment of the present invention.

FIG. 29 is a view showing a method of transmitting a packet using a compressed header according to another embodiment of the present invention.

FIG. 30 is a view showing an embodiment of deciding a time point when a header is omitted by a system information message (e.g., DCD, UCD).

FIG. 31 is a view showing an embodiment of deciding a time point when a header is omitted when a service is generated.

FIG. 32 is a view showing an embodiment of adjusting downlink traffic using map information elements suggested in the present invention.

FIG. 33 is a view showing an embodiment of adjusting downlink traffic using map information elements suggested in the present invention.

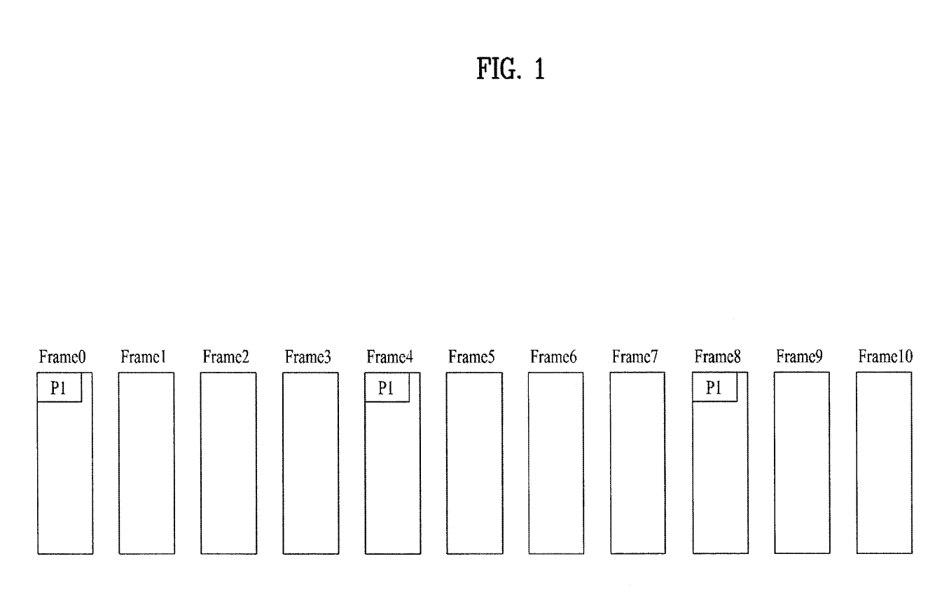

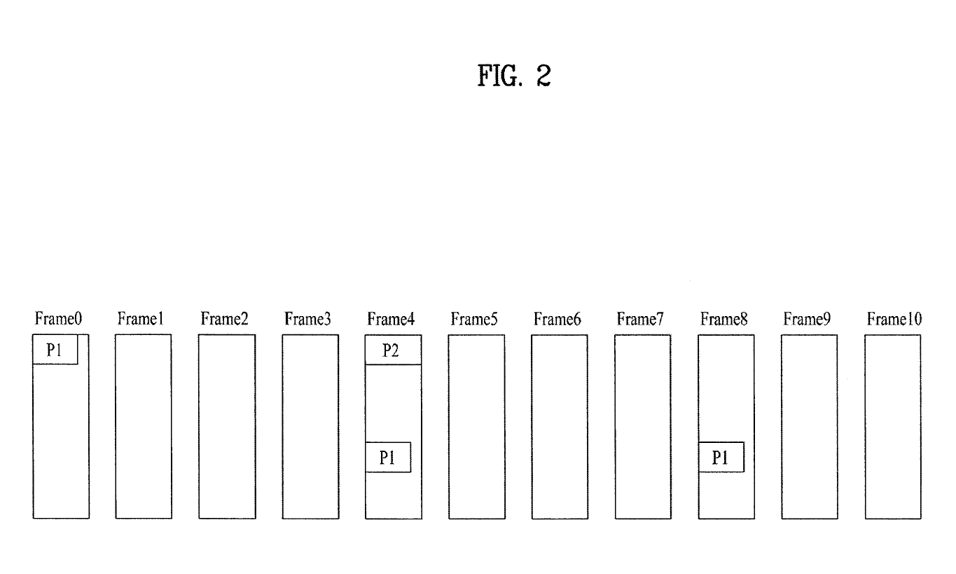

### BEST MODE

Reference will now be made in detail to the preferred embodiments of the present invention, examples of which are illustrated in the accompanying drawings. The detailed description set forth below in connection with the appended drawings is intended as a description of exemplary embodiments and is not intended to represent the only embodiments in which the concepts explained in these embodiments can be practiced. The detailed description includes details for the purpose of providing an understanding of the present invention. However, it will be apparent to those skilled in the art that these teachings may be implemented and practiced without these specific details.

In some instances, well-known structures and devices are omitted in order to avoid obscuring the concepts of the present invention and the important functions of the structures and devices are shown in block diagram form. The same reference numbers will be used throughout the drawings to refer to the same or like parts.

As described above, according to an embodiment of the present invention, there is provided a method of transmitting a packet including a compressed header by omitting a header including the same information as a header of a packet which is previously transmitted or omitting information overlapping with the header of the packet which is previously transmitted, such that header overhead is reduced when transmitting the packet.

In a detailed method, when a mobile station transmits a MAC header, an indicator indicating whether or not the MAC header is omitted from a MAC message or a compressed MAC header is used may be included.

Hereinafter, first, a method of transmitting a VoIP packet by a mobile station in a state of omitting a MAC header according to an embodiment of the present invention will be described in detail.

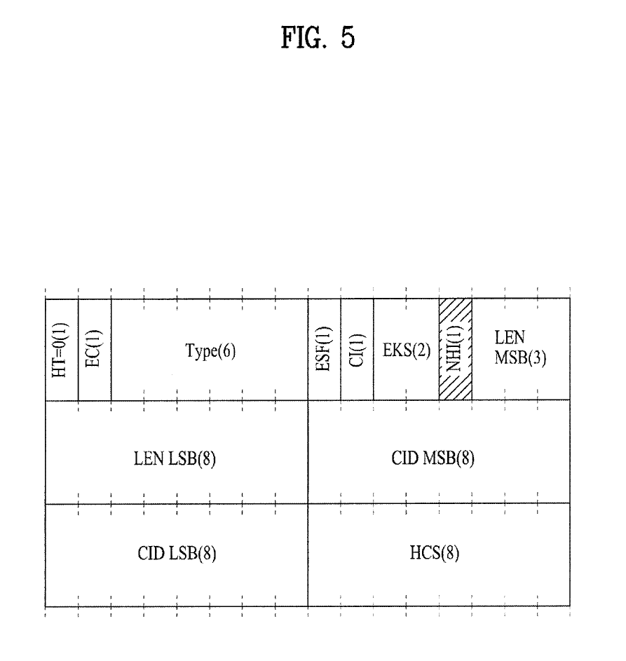

FIG. 5 is a view showing an example of a generic MAC header for supporting a method of transmitting a packet in a state of omitting a MAC header, according to an embodiment of the present invention.

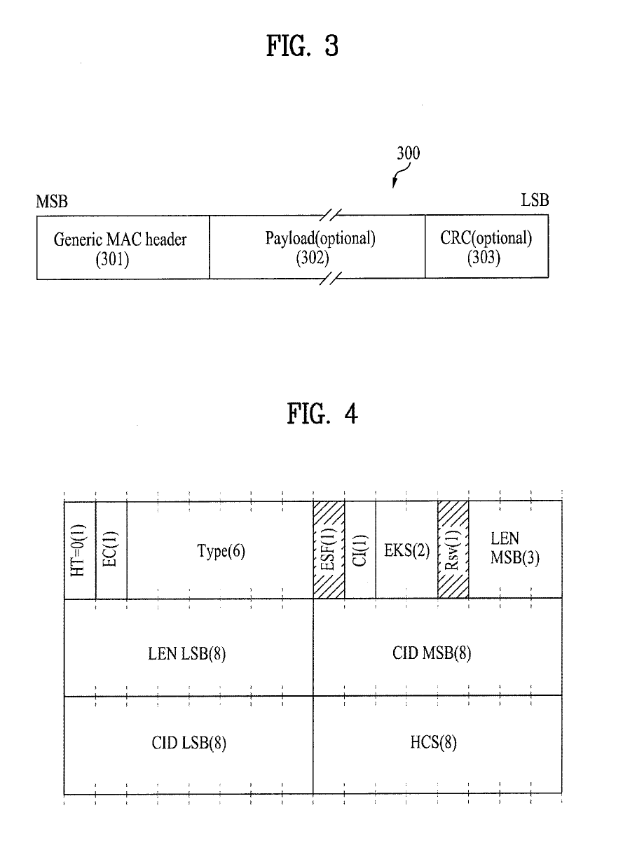

In the MAC header shown in FIG. 5, one reserved bit located next to the EKS field of the generic MAC header shown in FIG. 4 may be used as a next header indicator (NHI) bit. The NHI may indicate which MAC header is attached to a next MAC PDU with respect to a service corresponding to a current CID. In the present embodiment, the same MAC header as the existing packet is located if the NHI bit is set to 0 and the MAC header is omitted with respect to the next MAC header if the NHI bit is set to 1.

Hereinafter, a method of transmitting a VoIP packet using the above-described MAC header structure according to an embodiment of the present invention will be described.

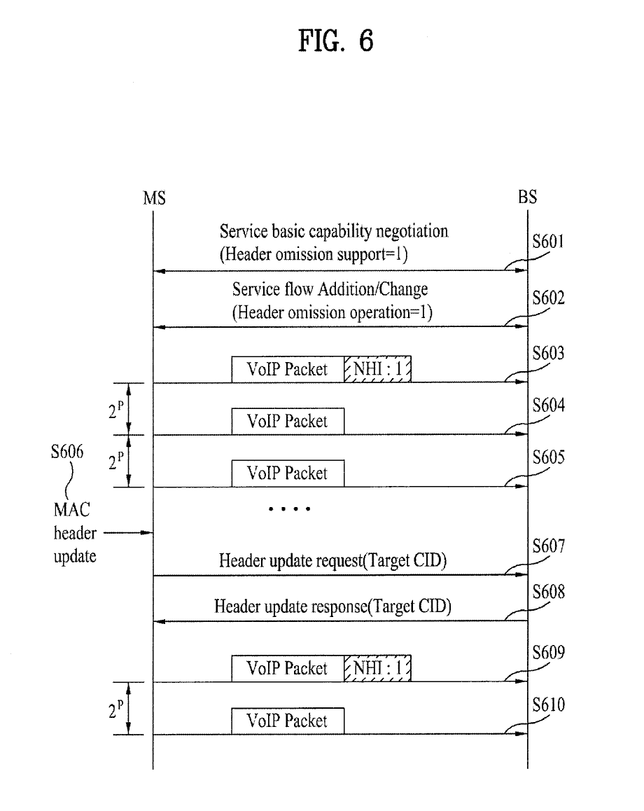

FIG. 6 is a view showing a method of transmitting a packet in a state of omitting a MAC header, according to an embodiment of the present invention.

In the present embodiment, when a mobile station negotiates with a base station for a basic service capability in a process of registering the mobile station in the base station (e.g., an SBC-REQ/RSP message exchange step), it may be determined whether the mobile station supports header omission. When a service is generated (e.g., a DSA-REQ/RSP message exchange step) or when a parameter related to the service is changed (e.g., a DSC-REQ/RSP message exchange step), a header omission operation may be activated or inactivated.

In the present embodiment, information indicating whether or not the mobile station supports the header omission is called “header omission support”. It is assumed that, if this parameter is 1, the mobile station supports the head omission function and, if this parameter is 0, the mobile station does not support the head omission function. In the present embodiment, information indicating whether or not the header omission operation is activated between the base station and the mobile station is called “header omission operation”. It is assumed that, if this parameter is 1, the header omission operation is activated and, if this parameter is 0, the header omission operation is inactivated.

FIG. 6 shows an example in which the mobile station supports the header omission function (that is, header omission support=1) in a basic capability negotiation step between the mobile station and the base station, that is, a step S601, and the header omission operation is activated (that is, header omission operation=1) in a step of generating or changing a service flow between the mobile station and the base station, that is, a step S602.

If the header omission operation is activated, the mobile station transmits a VoIP packet including a generic MAC header to an allocated region at a current frame (S603). At this time, the mobile station transmits the NHI of the generic MAC header, which is set to 1 as described with reference to FIG. 5, and informs the base station that the packet is transmitted in a state of omitting the header at a frame corresponding to a next period. Thereafter, the mobile station may transmit the VoIP packet in a state of omitting the header at the next periods (2^{p}) (S604 to S605).

Meanwhile, information which should be changed or updated (e.g., EKS, LEN or the like) in parameters related to the generic MAC header may be generated in the mobile station (S606). In this case, in a preferred embodiment of the present invention, a method of, at the mobile station, informing the base station that the header information should be updated is provided.

In the example of FIG. 6, the mobile station transmits a header update request message including a target CID to be changed to the base station (S607). When the base station receives the header update request message, the base station may transmit a header update response message to the mobile station in response thereto (S608).

The mobile station may transmit the VoIP packet including the generic MAC header at a frame corresponding to a next VoIP transmission period (S609). After the header update process is performed, the packet may be transmitted in a state of omitting the header again at a frame corresponding to a next period (S610). In this case, the NHI of the header of the packet transmitted in the step S609 is set to 1.

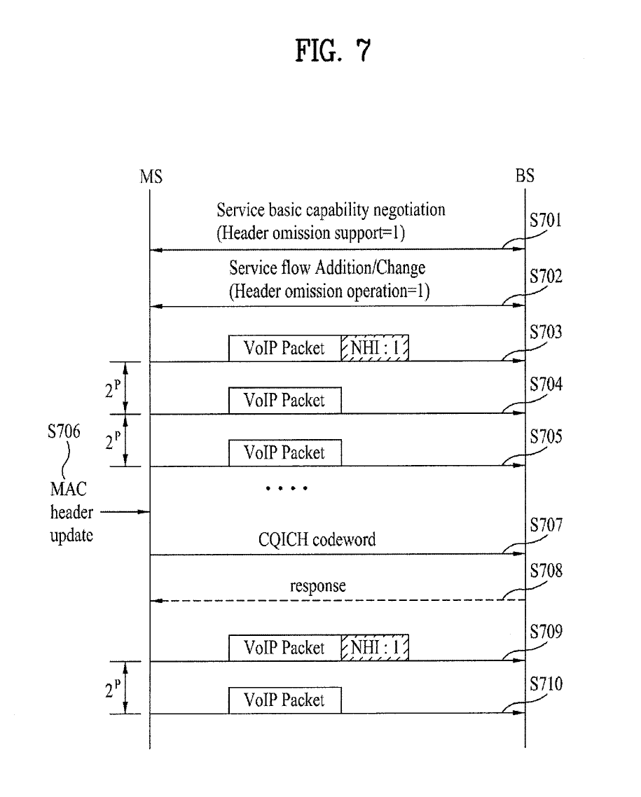

FIG. 7 is a view showing a method of transmitting a packet in a state of omitting a MAC header, according to another embodiment of the present invention.

The embodiment of the present invention shown in FIG. 7 is equal to the embodiment of FIG. 6 except for the process which is performed when the header information is updated or changed. Thus, only a step S706 related to the update or the change of the header information will be described in detail.

If the MAC header should be updated in the mobile station which transmits the packet in a state of omitting the header in steps S704 and S705, the mobile station may transmit a CQICH codeword, which is previously allocated for changing the header information of the mobile station, via a fast feed-back channel, and inform the base station of the change of the header (S707). At this time, a codeword which is previously specified for changing the header information between the mobile station and the base station may be used as the CQICH codeword. The base station which receives the specific CQICH codeword recognizes that the header needs to be updated and transmits a response message to the mobile station in a step S708. This response message may be transmitted in the format of, but not limited to, an UL_MAP IE.

The mobile station may transmit the VoIP packet including the generic MAC header at a frame corresponding to a next VoIP transmission period (S709). After the header update process is performed, the packet may be transmitted in a state of omitting the header again at a frame corresponding to a next period (S710). In this case, the NHI of the header of the packet transmitted in the step S709 is set to 1.

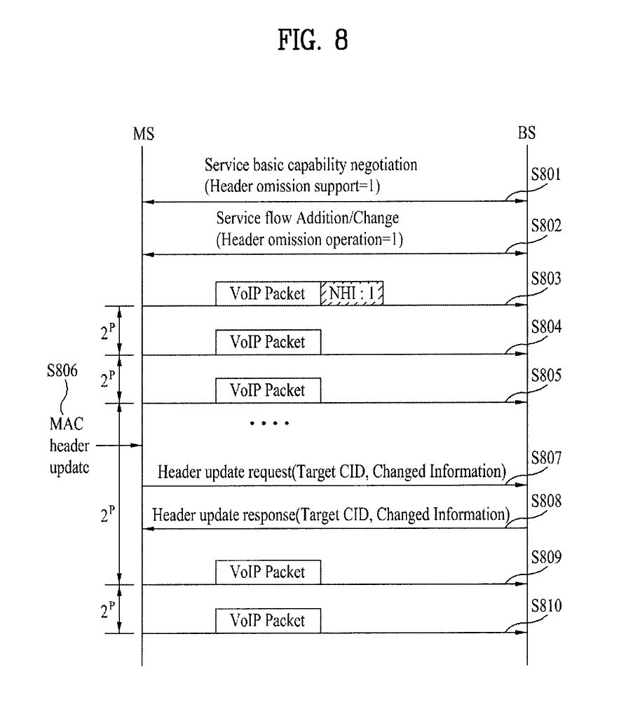

FIG. 8 is a view showing a method of transmitting a packet in a state of omitting a MAC header, according to another embodiment of the present invention.

Whereas the information to be updated is transmitted using the generic MAC header independent of the header update request message when the mobile station requests the header update in the embodiment shown in FIG. 6, in the embodiment shown in FIG. 8, the mobile station transmits the header update request message including the header information which needs to be updated, such that the header is not updated by additionally transmitting the generic MAC header.

That is, the embodiment shown in FIG. 8 is equal to the embodiment of FIG. 6 except for the process which is performed when the header information is updated or changed. Thus, only a step S806 related to the update or the change of the header information will be described in detail.

If the MAC header should be updated in the mobile station which transmits the packet in a state of omitting the header in steps S804 and S805, the mobile station may transmit a header update request message to the base station (S807). In the present embodiment, when the mobile station requests the header update to the base station, information to be updated is included in the header update request message. If the header update request message including the header information to be updated is transmitted, as described above, it is advantageous that the packet transmitted just after the header update request message is transmitted may be transmitted in a state of omitting the header.

The base station may receive the header update request message, update the information and transmit a header update response message to the mobile station (S808). At this time, the base station may transmit the header update response message including the information which is updated by the base station.

Accordingly, the mobile station may transmit the VoIP packet in a state of omitting the header at a frame corresponding to a next VoIP transmission period (S809).

In the above-described embodiments of the present invention, the packet can be transmitted in a state of omitting the header including the same information as the header of the packet which is previously transmitted, and the packet can be transmitted in a state of including an indicator indicating whether or not the header is omitted in a next packet. In the embodiments shown in FIGS. 6 to 8, the method of, at the mobile station, informing the base station that the header should be updated using the header update request message or the CQICH codeword if the header needs to be updated is suggested.

In the embodiments shown in FIGS. 6 to 8, an example of the header update request message which may be used for informing the base station that the header should be updated by the mobile station is as follows.

TABLE 1

| Syntax | Size | Notes |
|---|---|---|
| HDR_UPDATE-REQ message | — | — |
| format( ) { | | |
| Management message type = | 8 bits | — |
| xx | | |
| Target CID | 16 bits | — |
| CHI flag | 1 bit | Indicate whether or not |
| | | changed header information is |
| | | included |
| | | 0b0: The changed header |
| | | information is not included |
| | | 0b1: The changed header |
| | | information is included |
| If (CHI flag == 0b1) { | | |
| Changed header | variable | Changed MAC header |
| Information TLV | | information (e.g., CI, EKS, |
| | | Type, HCS, or the like) is |
| | | included in the format |
| | | of a TLV |
| } | | |
| } | | |

That is, if a “CHI flag” of the header update request message shown in Table 1 is 0b0, the changed MAC header information is not included in the header update request message like the embodiment described with reference to FIG. 6 and, if the “CHI flag” of the header update request message is 0b1, the changed MAC header information is included in the header update request message like the embodiment described with reference to FIG. 8.

An example of the update response message which is the response message of the header update request message shown in Table 1 in the embodiment is as follows.

TABLE 2

| Syntax | Size | Notes |
|---|---|---|
| HDR_UPDATE-RSP message | — | — |
| format( ) { | | |
| Management message type = | 8 bits | — |
| xx | | |
| Target CID | 16 bits | — |
| CHI flag | 1 bit | Indicate whether or not |
| | | changed header information |
| | | is included |
| | | 0b0: The changed header |
| | | information is not included |
| | | 0b1: The changed header |
| | | information is included |
| If (CHI flag == 0b1) { | — | — |
| Changed header | Variable | Changed MAC header |
| Information TLV | | information (e.g., CI, EKS, |
| | | Type, HCS, or the like) is |
| | | included in the format |
| | | of a TLV |
| } | | |
| } | | |

That is, the header update response message of Table may include or may not include the changed header information, depending on whether or not the changed header information is included in the header update request message.

In a preferred embodiment of the present invention, if the reception of the VoIP packet at the receiver fails by a predetermined number of times, a retransmission packet including the header is transmitted so as to increase a reception probability, which will now be described in detail.

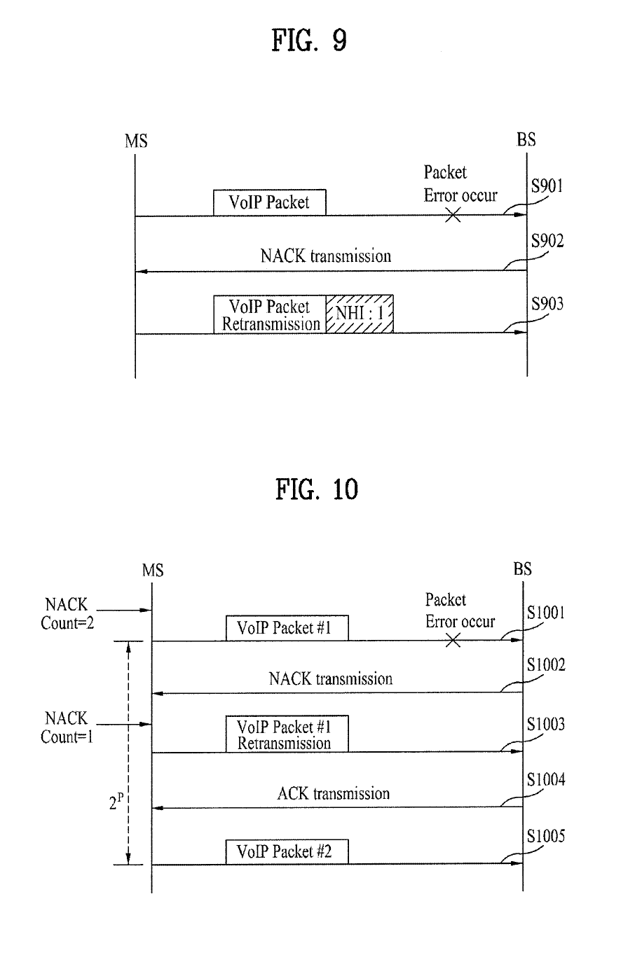

FIG. 9 is a view showing a method of transmitting a retransmission packet including a header when the reception of a packet fails, according to an embodiment of the present invention.

FIG. 9 shows a detailed example of the method of transmitting the retransmission packet including the header when the reception of the packet fails by a predetermined number of times, that is, the method of transmitting the retransmission packet including the header when the reception of the packet fails one time.

In more detail, in a step S901, when the mobile station transmits the packet in a state of omitting the header, a packet error may occur in a receiver. When the reception of the packet fails, the receiver may transmit a NACK to a transmitter in a step S902. In this case, the transmitter retransmits the packet including the header like the initial transmission (S903). Thus, the reception probability can be increased.

As a more generalized method of the present embodiment, the mobile station may define a NACK count in order to decide a time point, when the generic MAC header is transmitted, according to the number of NACKs which are continuously received. That is, when the initial VoIP packet is transmitted, the NACK count value is set to an initial value and the NACK count is decreased one by one whenever the mobile station receives the NACK. When the NACK count value becomes 0, the mobile station can transmit the retransmission packet including the generic header in order to increase the reception probability.

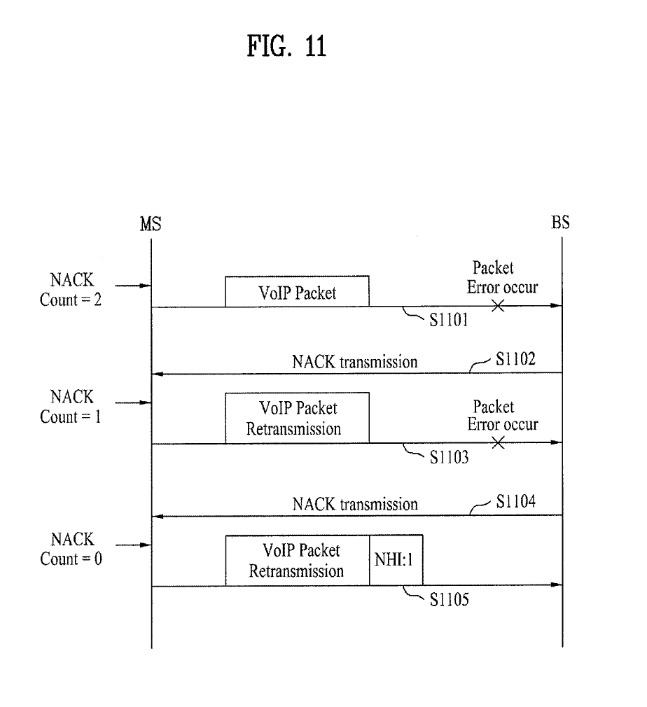

FIGS. 10 and 11 are views showing examples of a method of transmitting a retransmission packet including a header when the reception of a packet fails by a predetermined number of times, according to an embodiment of the present invention.

That is, FIGS. 10 and 11 show examples which are more generalized than FIG. 9, that is, examples of the method of maintaining the header omission until the reception of the packet fails by a predetermined number of times corresponding to the NACK count value and transmitting a retransmission packet including the header when the reception of the packet fails by the predetermined number of times corresponding to the NACK count value. In more detail, FIGS. 10 and 11 show the examples of the method of transmitting the retransmission packet including the header when the mobile station continuously receives the NACK two times.

Referring to FIG. 10, in a step S1001, it is assumed that the NACK count value is set to 2 and the reception of the packet fails when the mobile station transmits a first VoIP packet in a state of omitting the header. The base station may transmit a NACK in order to inform the mobile station that the reception of the packet fails (S1002). The mobile station which receives the NACK decreases the NACK count value by 1 and checks whether the NACK count value is 0. In the present example, if the NACK is received one time, the NACK count value is not 0 and thus the mobile station transmits the first VoIP packet without the header again in a step S1003. FIG. 10 shows an example in which the reception of the packet succeeds at the time of the retransmission of the packet and the base station transmits an ACK (S1004). Then, the mobile station may transmit a second VoIP packet without the header at a frame corresponding to a next period (S1005).

FIG. 11 shows an example in which the NACK is received two times with respect to the transmission of the packet without the header (S1102 and S1104) and the NACK count value is 0. If the NACK count value is 0, the retransmission packet may be transmitted in a state of including the header therein in order to increase the reception probability (S1105).

In another embodiment of the present invention, if the period for the transmission of a next packet is reached while the NACK is received with respect to the transmission of the VoIP packet without the header, the next packet may be transmitted in a state of including the generic header therein so as to increase the reception probability.

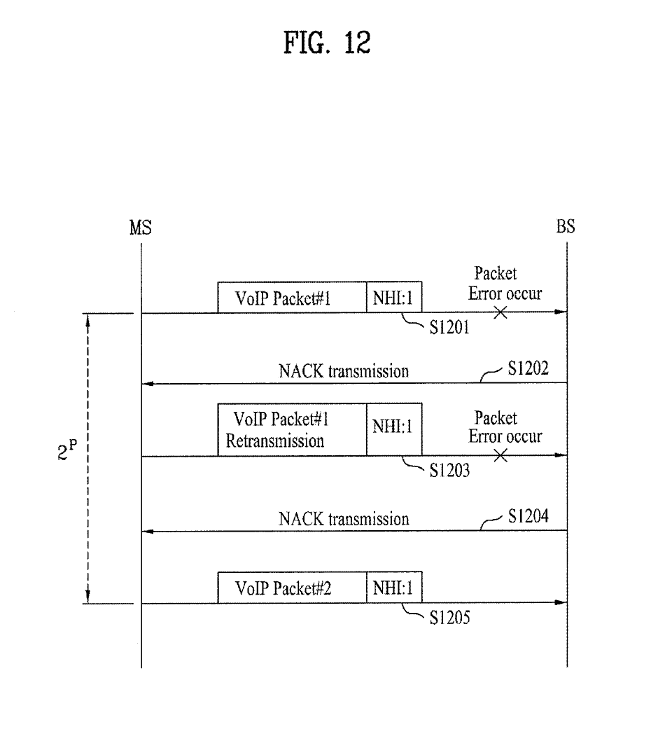

FIG. 12 is a view showing a method of transmitting a next packet including a generic header when a next packet transmission period is reached while a NACK is received due to the failure of the packet reception, according to another embodiment of the present invention.

In more detail, it is assumed that the mobile station transmits a first VoIP packet indicating that the header of a next packet is omitted (that is, NHI=1) in a step S1201, but the base station cannot receive the packet. In this case, the base station may transmit a NACK to the mobile station (S1202). Then, the mobile station transmits a first packet indicating that the header is omitted (S1203). FIG. 12 shows the case where the reception of the first VoIP packet which is retransmitted also fails. If the next packet transmission period is reached while the NACK is received due to the failure of the reception of the first VoIP packet, in the present embodiment, a second VoIP packet may be transmitted without omitting the header of the next packet so as to increase the reception probability (S1205).

Although the uplink packet transmission in which the transmitter is the mobile station and the receiver is the base station is described in the above-described embodiments, the present invention is limited to the uplink packet transmission and the description of the above-described embodiments may be directly or indirectly used in the downlink packet transmission by the same principle.

In another embodiment of the present invention, a method of informing a counterpart of a header update state (that is, contents indicating that the generic MAC header should be included) using a header (e.g., a signaling header, a subheader, an extended header or the like) without using a MAC management message like the above-described embodiments in order to update the header is suggested.

In this embodiment, the case where the signaling header is used for updating the header will be first described.

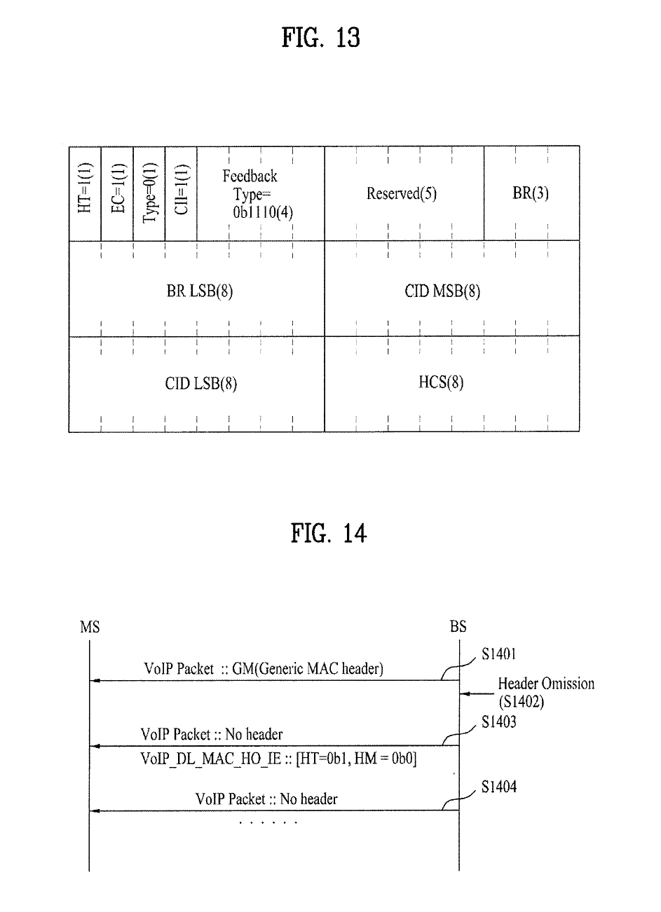

FIG. 13 is a view showing an example of a MAC signaling header which may be used for informing the header update, according to an embodiment of the present invention.

In more detail, the MAC signaling header shown in FIG. 13 has a header type 2 (HT/EC=0b11). The type of the header shown in FIG. 13 includes an additional 4-bit type field (a “Feedback Type” field shown in FIG. 13) as a feedback header. In addition, a CID inclusion indication (CII) field indicates whether or not the CID is included. If the CII is 1, it is indicated that the CID is included and, if the CII is 0, it is indicated that the CID is not included. The “Feedback Type” field is specified to 0b1110 so as to indicate that the feedback header is used for updating the header.

Next, in the above-described embodiment, the extended subheader used for updating the header will be described.

Table 3 shows an example of a list of extended subheaders used for the downlink (DL).

TABLE 3

| | | ES body | |
|---|---|---|---|
| ES type | Name | size | Description |
| 0 | SDU_SN extended subheader | 1 byte | See 6.3.2.2.7.1 |
| 1 | DL Sleep control extended | 3 bytes | See 6.3.2.2.7.2 |
| | subheader | | |
| 2 | Feedback request extended | 3 bytes | See 6.3.2.2.7.3 |
| | subheader | | |
| 3 | SN request extended subheader | 1 byte | See 6.3.2.2.7.7 |
| 4 | PDU SN(short) extended | 1 byte | See 6.3.2.2.7.8 |
| | subheader | | |
| 5 | PDU SN(long) extended subheader | 2 bytes | See 6.3.2.2.7.8 |
| 6 | Header Update extended subheader | 2 bytes | — |
| 7-27 | Reserved | — | — |

The index described in “description” of Table 3 indicates the index of the IEEE 802.16e standard document. In the present embodiment, the extended subheader for informing the downlink header update is added to the ES type 6 of “Description of extended subheaders type (DL)” of the IEEE 802.16e standard document. That is, according to the present embodiment, the downlink header update may be informed using the extended subheader corresponding to the ES type 6. It is apparent to those skilled in the art that the extended subheader which can be used for the downlink header update may be added as any type of the reserved ES type 7 to 27 as well as the ES type 6 in Table 3.

Table 4 shows an example of a list of the extended subheaders used for the uplink.

TABLE 4

| | | ES body | |
|---|---|---|---|
| ES type | Name | size | Description |
| 0 | MIMO mode feedback extended | 1 byte | See 6.3.2.2.7.4 |
| | subheader | | |
| 1 | UL Tx Power Report extended | 1 byte | See 6.3.2.2.7.5 |
| | subheader | | |
| 2 | Mini-Feedback extended | 2 byte | See 6.3.2.2.7.6 |
| | subheader | | |
| 3 | PDU SN (short) extended | 1 byte | See 6.3.2.2.7.8 |
| | subheader | | |
| 4 | PDU SN (long) extended | 2 bytes | See 6.3.2.2.7.8 |
| | subheader | | |
| 5 | Header Update extended | 2 bytes | — |
| | subheader | | |
| 6-27 | Reserved | — | — |

The index described in “description” of Table 4 also indicates the index of the IEEE 802.16e standard document. In the present embodiment, the extended subheader for informing the uplink header update is added to the ES type 5 of “Description of extended subheaders type (UL)” of the IEEE 802.16e standard document. That is, according to the present embodiment, the uplink header update may be informed using the extended subheader corresponding to the ES type 5. The extended subheader which can be used for the uplink header update may be added as any type of the reserved ES type 6 to 27 as well as the ES type 5 in Table 4.

An example of the format of the extended subheader for the header update may be expressed as follows in association with Table 3 and Table 4.

TABLE 5

| Name | Size | Description |
|---|---|---|
| CID | 16 bits | Corresponding CID is indicated |

The above-described embodiments relate to the method of changing the generic MAC header and informing whether or not the header is updated.

Hereinafter, a method of informing whether or not the header is omitted when the packet is transmitted via the MAP IE (and/or whether or not the header is updated) according to another embodiment of the present invention will be described. That is, in the below-described embodiment of the present invention, the base station may inform the mobile station whether or not the header is omitted or instruct the omission of the header via the DL/UL-MAP IE.

Table 6 shows an example of the extended DIUC code which is available when the base station informs the mobile station whether or not the header is omitted with respect to the downlink VoIP service according to an embodiment of the present invention.

TABLE 6

| Extended DIUC | |
|---|---|
| (hexadecimal) | Usage |
| 00 | Channel_Measurement_IE |
| 01 | STC_Zone_IE |
| 02 | AAS_DL_IE |
| 03 | Data_location_in_another_BS_IE |
| 04 | CID_Switch_IE |
| 05 | VoIP DL MAC HO(header omission) IE |
| 06 | Reserved |
| 07 | HARQ_Map_Pointer_IE |
| 08 | PHYMOD_DL_IE |
| 09-0A | Reserved |
| 0B | DL PUSC Burst Allocation in Other Segment |
| 0C | PUSC ASCA ALLOC IE |
| 0D-0E | Reserved |
| 0F | UL_interference_and_noise_level_IE |

That is, Table 6 shows an example in which the extended DIUC 05 is defined for the downlink MAC header omission (VoIP_DL_MAC_HO (header omission)_IE) for the VoIP service. For the MAC header omission VoIP_DL_MAC_HO_IE, in Table 6, VoIP_DL_IE may be defined in the extended DIUC (e.g., 06, 09-0A, 0D-0E) represented by “reserved”. Although the extended DIUC is specified in order to define VoIP_DL_MAC_HO_IE in the above-described example, it may be allocated in the basic DIUC or the extended DIUC 2.

If the extended DIUC is defined as shown in Table 6, the mobile station may determine whether or not the header is omitted with respect to the VoIP packet transmission when the extended DIUC is 05.

An example of VoIP_DL_MAC_HO_IE specified by the extended DIUC is shown in Table 7.

TABLE 7

| Syntax | Size | Notes |
|---|---|---|
| VoIP DL MAC HO IE ( ) { | — | — |
| Extended DIUC | 4 bits | VoIP DL MAC HO = 0x05 |
| Length | 4 bits | — |
| CID | 16 bits | CID corresponding to VoIP |
| | | connection |
| HT | 1 bit | Header Type (HT) |
| | | 0b0: General MAC header |
| | | 0b1: VoIP header omission |
| HM | 1 bit | Header Maintaining (HM) |
| | | It is indicated whether a current |
| | | header type will be continuously |
| | | used even in next transmission |
| | | 0b0: The current header type is |
| | | maintained even in the next |
| | | transmission |
| | | 0b1: The header type is applied to |
| | | only the current frame |
| } | — | — |

That is, in VoIP_DL_MAC_HO_IE of Table 7, it is indicated whether or not the header of the packet which is currently transmitted is omitted or whether or not the header is omitted for the update using the HT field. In addition, it is indicated whether or not the header of a next frame will be omitted using the HM field.

FIG. 14 is a view showing a method of omitting a header using an MAP IE when a downlink packet is transmitted, according to an embodiment of the present invention.

In more detail, FIG. 14 shows an example in which the base station generates a header omission event.

If the base station generates the header omission event (S1402) while the base station transmits a VoIP packet using a generic MAC header (GM) (S1401), the VoIP packet without the MAC header may be transmitted (S1403). At this time, the base station may transmit VoIP_DL_MAC_HO IE, in which a HT is set to 0b1, to the mobile station at the same frame in order to inform the mobile station of the header omission, and may transmit VoIP_DL_MAC_HO IE, in which a HM is set to 0b0, when the current header type is maintained even in the next frame.

The mobile station which receives VoIP_DL_MAC_HO IE determines that the header is not present in the current VoIP packet, using the HT which is set to 0b1. It is determined that the same header as the current frame is used with respect to the VoIP packet transmitted at a next frame, using the HM which is set to 0b0. Thereafter, the base station transmits the VoIP packet in a next period in a state of omitting the header (S1404).

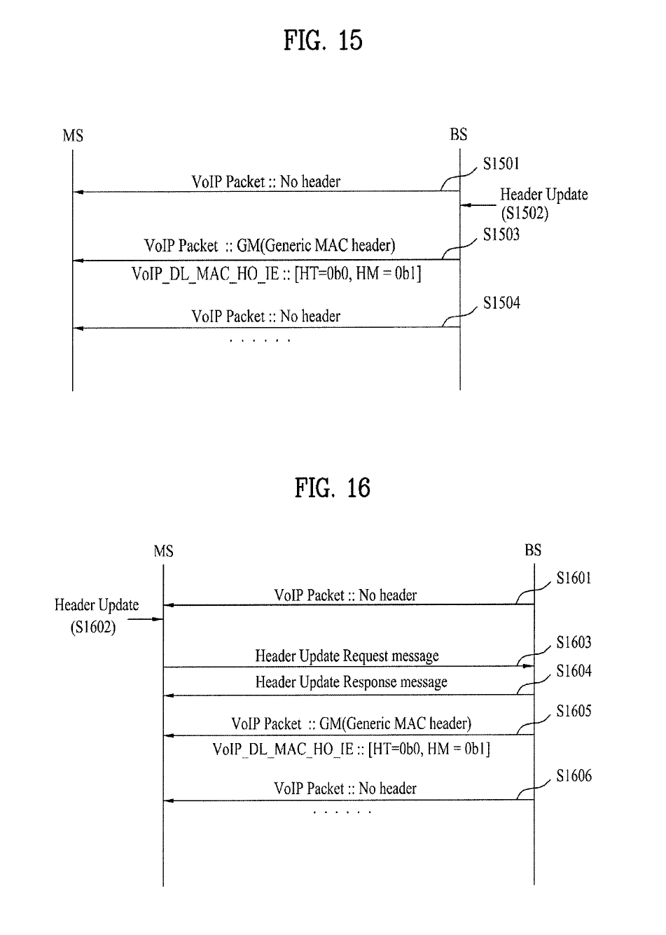

FIG. 15 is a view showing a method of omitting and updating a downlink header using an MAP IE, according to another embodiment of the present invention.

In more detail, FIG. 15 shows another example in which the base station generates a header update event.

That is, if the header needs to be updated (S1502) while the base station transmits a packet without a MAC header (S1501), VoIP_DL_MAC_HO IE indicating the usage of the generic MAC header (HT=0b0) together with the VoIP packet using the generic MAC header is transmitted to the mobile station (S1503). At this time, if the header update is completed using the generic MAC header which is currently transmitted, the HM of the VoIP_DL_MAC_HO IE transmitted in the step S1503 is set to 0b1 in order to indicate that the header is omitted at a next frame unlike the packet which is currently transmitted.

The mobile station recognizes that the header is not omitted at the current frame for the header update, using the HT of the received VoIP_DL_MAC_HO IE which is set to 0b0 and recognizes that the header type of the packet transmitted at the current frame is not maintained in the header of the packet transmitted at the next frame, that is, the header is omitted, using the HM of the received VoIP_DL_MAC_HO IE which is set to 0b1. Thereafter, the base station transmits the VoIP packet without the header to the mobile station at a frame corresponding to a next period (S1504).

FIG. 16 is a view showing a method of omitting and updating a downlink header using an MAP IE, according to another embodiment of the present invention.

In more detail, FIG. 16 shows another example in which the mobile station generates a header update event.

That is, if the mobile station which receives a packet without the header (S1601) generates the header update event (1602), the mobile station may inform the base station that the header update event is generated by a header update request message (S1603). That is, in the present embodiment using the MAP IE, if the header update event is generated by the mobile station instead of the base station, an additional process of enabling the mobile station to inform the base station that the header update event is generated is required. Then, the base station may transmit the MAP IE indicating the header update.

The base station transmits a header update response message to the mobile station in response to the header update request message of the mobile station (S1604) and transmits the VoIP packet including the generic MAC header therein (S1605). At this time, in the VoIP_DL_MAC_HO IE transmitted together with the VoIP packet including the generic MAC header, the HT is set to Obi in order to represent that the generic MAC header is included and the HM is set to 0b1 in order to represent that the next VoIP packet without the header is transmitted because the header update is completed.

The mobile station which receives the VoIP_DL_MAC_HO IE recognizes that the current VoIP packet includes the header and the next VoIP packet does not include the header, and receives the VoIP packet without the header in a step S1606.

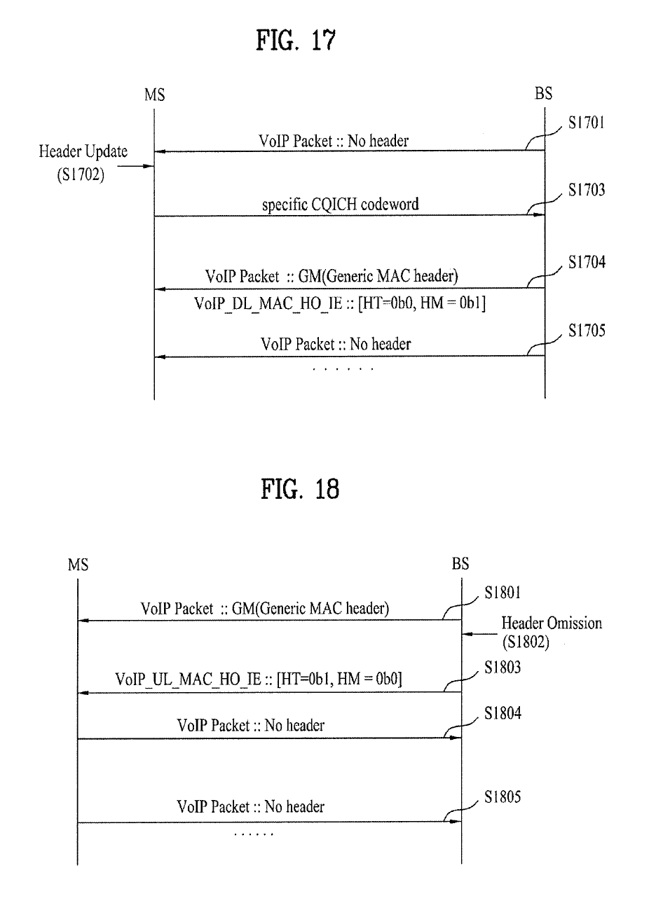

FIG. 17 is a view showing a method of omitting and updating a downlink header using a specific CQICH codeword, according to another embodiment of the present invention.

In more detail, FIG. 17 shows a method of informing the base station whether or not the header update event is generated using a specific CQICH codeword when the mobile station generates a header update event, instead of the method of transmitting the header update request message shown in FIG. 16.

If a header should be updated (S1702) while the mobile station receives a packet without a MAC header (S1701), the specific CQICH codeword is transmitted to the base station such that the base station is informed that the header update event is generated (S1703). As described above, as the specific CQICH codeword used at that time, a codeword which is previously decided between the base station and the mobile station in order to represent the generation of the header update event may be used.

Then, the base station transmits a VoIP packet to the mobile station using a generic MAC header together with VoIP_DL_MAC_HO IE (HT=0b0) indicating the use of the generic MAC header (S1704). If the HM of the VoIP_DL_MAC_HO IE is set to Obi, the mobile station determines that the MAC header transmitted at a current frame is applied to only the current frame. Accordingly, the mobile station may transmit the VoIP packet without the header to the mobile station at a frame corresponding to a next period (S1705).

Hereinafter, a method of supporting the omission of the header with respect to the uplink VoIP service according to an embodiment of the present invention will be described.

Table 8 shows an example of an extended UIUC code which can be used for representing whether or not the header is omitted with respect to the uplink VoIP service.

TABLE 8

| Extended | |
|---|---|
| UIUC | |
| (hexadecimal) | Usage |
| 00 | Power_control_IE |
| 01 | Mini-subchannel_allocation_IE reserved |
| 02 | AAS_UL_IE |
| 03 | CQICH_Alloc_IE |
| 04 | UL Zone IE |
| 05 | PHYMOD_UL_IE |
| 06 | VoIP_UL_IE |
| 07 | UL-MAP_Fast_Tracking_IE |
| 08 | UL_PUSC_Burst_Allocation_in_Other_Segment_IE |
| 09 | Fast_Ranging_IE |
| 0A | UL Allocation Start IE |
| 0B | VoIP UL MAC header omission IE |
| 0C-0F | Reserved |

That is, Table 8 shows an example of defining “VoIP UL MAC header omission IE” such that the extended UIUC OB represents the uplink MAC header omission for the VoIP service. For VoIP UL MAC header omission IE for VoIP allocation, the VoIP UL MAC header omission IE may be defined in the extended UIUC OC to OF represented by “reserved”. Although the extended UIUC is specified in order to define the VoIP UL MAC header omission IE, the VoIP UL MAC header omission IE may be allocated in a basic UIUC or an extended UIUC 2.

If the extended UIUC is defined like Table 8, the mobile station determines that 0B of the extended UIUC includes the information element indicating whether or not the header is omitted with respect to the uplink VoIP packet transmission.

An example of the VoIP_UL_MAC_header omission IE specified by the extended UIUC is shown in Table 9.

TABLE 9

| Syntax | Size | Notes |
|---|---|---|
| VoIP UL MAC HO IE ( ) { | — | — |
| Extended DIUC | 4 bits | VoIP UL MAC HO = 0x0B |
| Length | 4 bits | — |
| CID | 16 bits | CID corresponding to VoIP |
| | | connection |
| HT | 1 bit | Header Type (HT) |
| | | 0b0: General MAC header |
| | | 0b1: VoIP header omission |
| HM | 1 bit | Header Maintaining (HM) |
| | | It is indicated that a current header |
| | | type is continuoulsy used even in |
| | | next transmission |
| | | 0b0: maintain the current header |
| | | type even in next transmission |
| | | 0b1: apply the header type to |
| | | only a current frame |
| } | — | — |

That is, in the VoIP_UL_MAC_HO_IE shown in Table 9, a HT field indicates whether or not the header of the packet which is currently transmitted is omitted or whether or not the header is omitted for update and a HM field indicates whether or not the header of a next frame is omitted.

A detailed method of supporting the header omission and update using an UL_MAP IE will be described.

FIG. 18 is a view showing a method of omitting a header using an UL_MAP IE when an uplink packet is transmitted, according to an embodiment of the present invention.

In more detail, FIG. 18 shows a method of instructing the mobile station to omit the header using the UL_MAP IE when the base station generates a header omission event.

That is, when the base station generates the header omission event (S1802) while the base station receives a VoIP packet including a generic MAC header (S1801), VoIP_UL_MAC_HO IE in which a HT is set to 0b1 and a HM is set to 0b0 is transmitted to the mobile station (S1803).

Then, the mobile station may transmit the VoIP packet without the header to the base station by the HT=0b1 (S1804). In addition, the mobile station may transmit the VoIP packet without the header in a next period by the HM=0b0 (S1805).

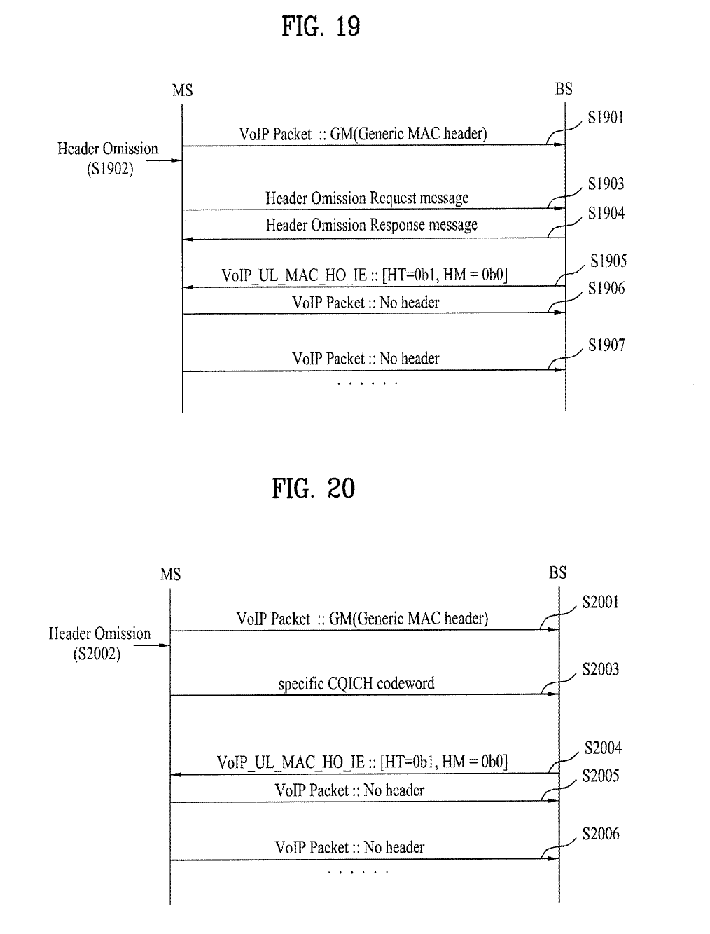

FIG. 19 is a view showing a method of omitting a header using an UL_MAP IE when an uplink packet is transmitted, according to another embodiment of the present invention.

In more detail, FIG. 19 shows an example of informing the base station that a header omission event is generated by a header omission request message when the mobile station generates the header omission event. That is, when the header omission event is generated by the mobile station instead of the base station, a separate process of informing the base station that the header omission event is generated by the mobile station is required. Then, the base station may instruct the mobile station to omit the UL_MAP IE.

That is, when the header omission event is generated (S1902) while the mobile station transmits a VoIP packet including a generic MAC header (S1901), in the present embodiment, the mobile station transmits a header omission request message to the base station (S1903).

The base station transmits a header omission response message to the mobile station in response to the header omission request message (S1904). The base station may transmit the VoIP_UL_MAC_HO IE, in which a HT is set to 0b1 and a HM is set to 0b0, to the mobile station before the transmission of a next period (S1905). Then, the mobile station transmits the VoIP packet without the header to the base station by the HT=0b1 (S1906), and transmits the VoIP packet without the header in a next period by the HM=0b0 (S1907).

FIG. 20 is a view showing a method of omitting a header using a specific CQICH codeword when an uplink packet is transmitted, according to another embodiment of the present invention.

In more detail, FIG. 20 shows a method of informing the base station whether or not the header update event is generated using a specific CQICH codeword when the mobile station generates a header update event, instead of the method of transmitting the header update request message like FIG. 19, and, at the base station, informing the mobile station whether or not the header is omitted using the UL_MAP IE.

That is, if the header omission event is generated (S2002) while the mobile station transmits a VoIP packet including a generic MAC header (S2001), the specific CQICH codeword which is previously decided between the base station and the mobile station in order to represent the generation of the header update event is transmitted to the base station (S2003).

The base station which receives the CQICH codeword can know that the mobile station omits the header in a next period. Accordingly, the base station may transmit a VoIP_UL_MAC_HO IE, in which a HT is set to 0b1 and a HM is set to 0b0, to the mobile station before the transmission of a next period (S2004).

The mobile station which receives the UL_MAP IE may transmit the VoIP packet without the header to the base station by the HT=0b1 (S2005). The mobile station may transmit the VoIP packet without the header in the next period by the HM=0b0 (S2006).

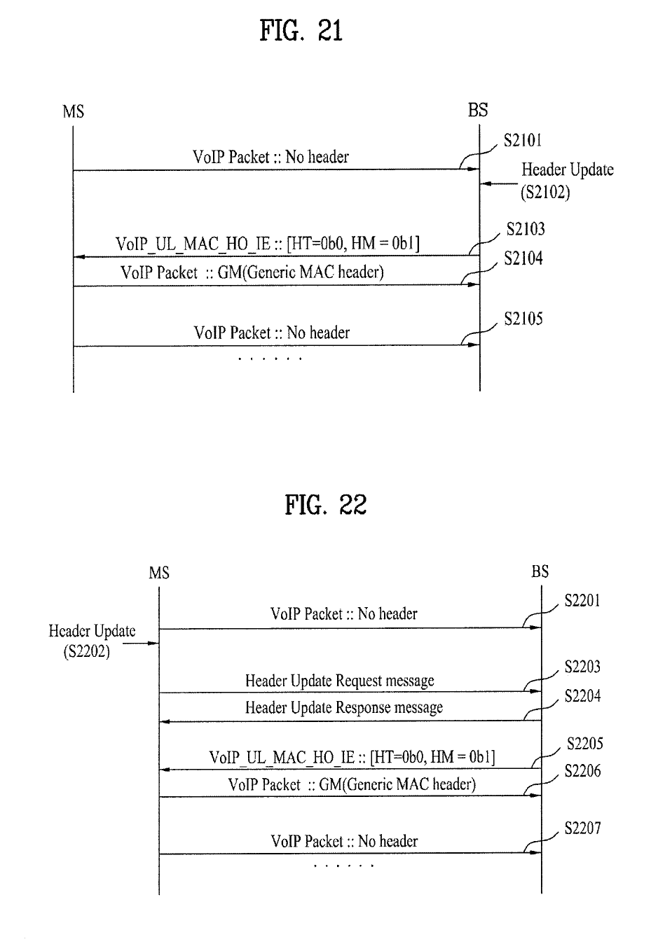

FIG. 21 is a view showing a method of transmitting an uplink packet in a state in which a header is omitted, by informing whether or not the header is updated using an UL_MAP IE, according to another embodiment of the present invention.

In more detail, FIG. 21 shows an example of informing the mobile station that a header update event is generated using the UL_MAP IE when the base station generates the header update event.

That is, if the header update event is generated (S2102) while the base station receives a VoIP packet without a MAC header (S2101), in the present embodiment, the base station transmits VoIP_UL_MAC_HO IE, in which a HT is set to 0b1 and a HM is set to 0b1, to the mobile station (S2103).

The mobile station which receives the VoIP_UL_MAC_HO IE may transmit a VoIP packet including a generic MAC header to the base station by the HT=0b0 (S2104). The mobile station may transmit the VoIP packet without the header in a next period by the HM=0b1, unlike the previous period (S2105).

FIG. 22 is a view showing a method of transmitting an uplink packet in a state of omitting a header, by informing whether or not the header is updated using a header update request message, according to another embodiment of the present invention.

In more detail, FIG. 22 shows a method of, at the mobile station, informing the base station whether or not the header update event is generated using a header update request message when the mobile station generates the header update event and, at the base station, informing the mobile station whether or not the header is updated and omitted using the UL_MAP IE.

That is, if the header update event is generated (S2202) while the mobile station transmits a VoIP packet without the header (S2201), in the present embodiment, the mobile station transmits a header update request message to the base station (S2203).

Then, the base station transmits a header update response message to the mobile station in response to the header update request message (S2204). Thereafter, the base station transmits a VoIP_UL_MAC_HO IE, in which a HT is set to 0b0 and a HM is set to 0b1, to the mobile station before the transmission of a next period (S2205).

The mobile station which receives the VoIP_UL_MAC_HO IE may transmit a VoIP packet including a generic header to the base station by the HT=0b0 and update the header (S2206). The mobile station may transmit the VoIP packet without the header in a next period by the HM=0b1 (S2207).

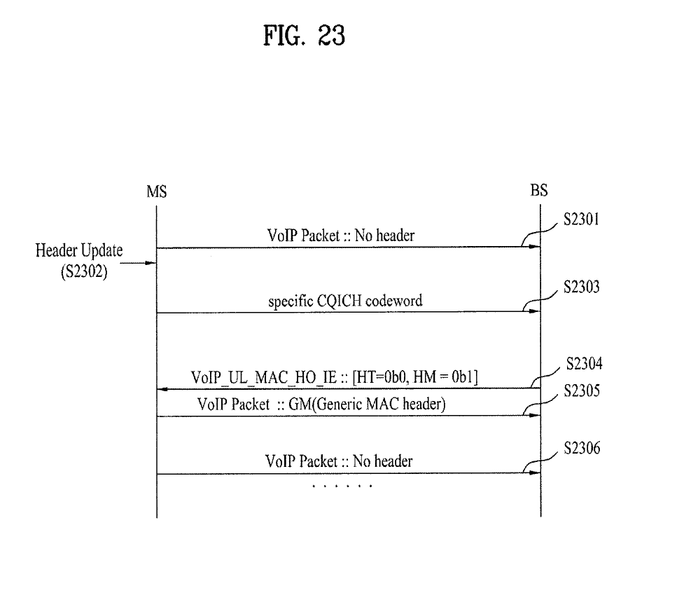

FIG. 23 is a view showing a method of transmitting an uplink packet in a state of omitting a header, by informing whether or not the header is updated using a specific CQICH codeword, according to another embodiment of the present invention.

In more detail, FIG. 23 shows an example of informing the base station that the header update event is generated using the specific CQICH codeword when the mobile station generates the header update event and, at the base station, informing the mobile station whether or not the header is updated and omitted using a UL_MAP IE.

That is, if the header update event is generated (S2302) while the mobile station transmits a VoIP packet without a MAC header (S2301), in the present embodiment, the mobile station transmits the specific CQICH codeword, which is previously decided between the base station and the mobile station in order to indicate whether or not the header is updated, to the base station (S2303).

The base station which receives the specific CQICH codeword knows that the mobile station will update the header in a next period. Then, the base station transmits a VoIP_UL_MAC_HO IE, in which a HT is set to 0b0 and a HM is set to 0b1, to the mobile station before the transmission of the next period (S2304).

The mobile station which receives the VoIP_UL_MAC_HO IE may transmit a VoIP packet including a generic header to the base station by HT=0b0 and update the header (S2305). The mobile station may transmit the VoIP packet without the header in the next period (S2306).

As described above, a method of representing the header omission and update using the MAP IE may be equally applied to a method of transmitting a packet by the compression of a header according to an embodiment of the present invention, which will be described later.

Hereinafter, a method of compressing and transmitting a header in a specific situation in order to reduce the header overhead when a packet is transmitted according to another embodiment of the present invention will be described.

In an example of a header for supporting the compression according to the present embodiment, similar to the embodiment using the header omission, a one reserved bit located next to the existing EKS is allocated as a NHI bit in the generic MAC header shown in FIG. 5. If the NHI is set to 0, the same MAC header as the existing header is located and, if the NHI is set to 1, the header is compressed unlike the above-described embodiment in which the header is omitted.

The example of the compressed header according to the present embodiment is as follows.

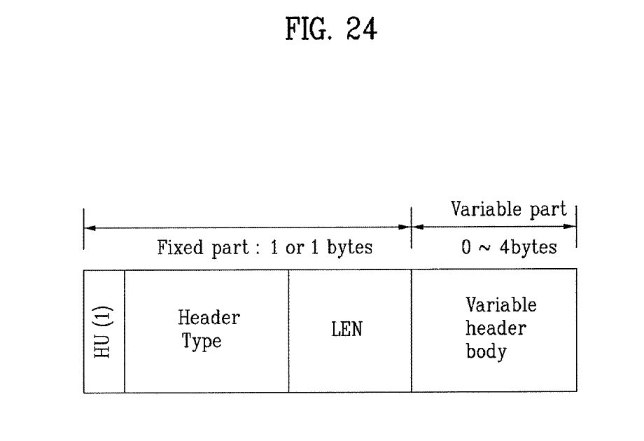

FIG. 24 is a view showing an example of a compressed MAC header according to an embodiment of the present invention.

As shown in FIG. 24, the compressed MAC header may be divided into a fixed part and a variable part. The fixed part may have a length of any one of 1 byte or 2 bytes. The length of the variable part is decided according to a header type and may have a variable length of 0 to 4 bytes. The lengths of the fixed part and the variable part may be changed.

A receiver which receives a MPDU (MAC PDU) may first read the fixed part and then read the variable part according to the header type. The fields of the compressed header of FIG. 24 will be described as follows.
A header update (HU) flag is a flag bit indicating whether a generic MAC header or a compressed MAC header is used in a next header. If this bit is set to 0, the next header may be transmitted as the same header as a current header. If the HU bit is set to 1, the receiver may be informed that the generic MAC header is transmitted at a next frame.
A header type field indicates the type of a current compressed MAC header. The length of the MAC header and the contents of the variable part may be decided by the header type field.
A length (LEN) field indicates the length of the MPDU.
A variable part (or a variable header body) field of which the contents may be changed according to the header type value and may selectively include at least one of the fields of the generic MAC header (e.g., a CI, an EKS, a type, a HCS, or the like). A transmitter may transmit header change information.

The fields which may be included in the variable part of the compressed MAC header according to the present embodiment will be described as follows.

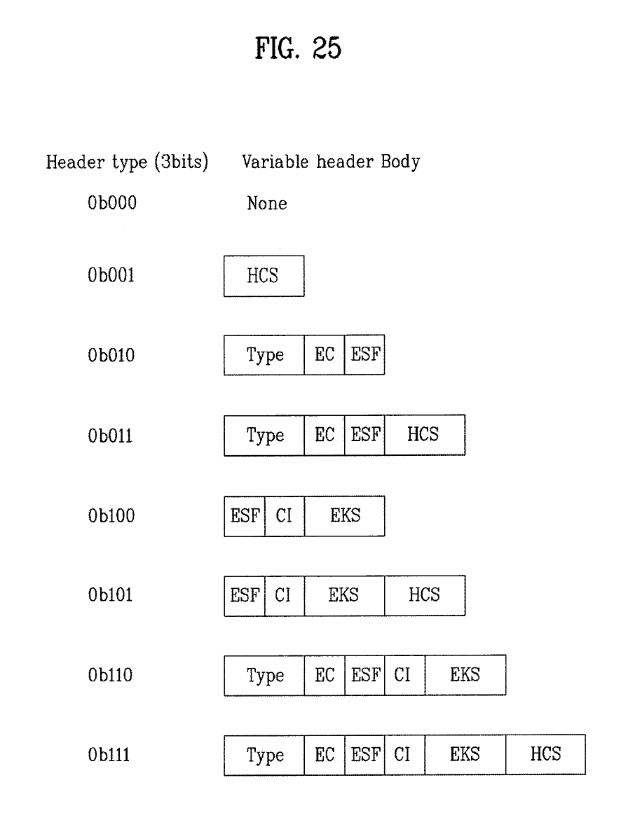

FIG. 25 is a view showing examples of fields which may be included in a variable part of a compressed MAC header according to an embodiment of the present invention.

FIG. 25 shows examples in which the header type has 3 bits and eight variable parts may be represented according to the 3-bit header type. The number of examples of the variable parts which are applied according to the length of the header type may be changed and the fields configuring the examples may be changed according to the requirements of the system.

In the example shown in FIG. 25, no field is included in the variable part if the header type is “0b000”, only a HCS field is included in the variable part if the header type is “0b001”, and a type field, an EC field and an ESF field are included in the variable part if the header type is “0b010”. The type field, the EC field, the ESF field and the HCS field is included in the variable part if the header type is “0b011”, and the ESF field, the CI field and the EKS field are included in the variable part if the header type is “0b100”. The ESF field, the CI Field, the EKS field and the HCS field are included in the variable part if the header type is “0b101”, the type field, the EC field, the ESF field, the CI field and the EKS field are included in the variable part if the header type is “0b110”, the type field, the EC field, the ESF field, the CI field and the EKS field are included in the variable part if the header type is “0b110”, and the type field, the EC field, the ESF field, the CI field, the EKS field and the HCS field are included in the variable part if the header type is “0b111”.

Hereinafter, the detailed examples of the method of transmitting the packet using the compressed headers according to the present embodiment will be described. In order to apply the method of transmitting the packet using the compressed header, information indicating whether or not a header compression function is supported needs to be exchanged in the basic capability negotiation process (e.g., the step S601 of FIG. 6) according to the embodiment of the method of transmitting the packet using the header omission, and information indicating whether or not a header compression function is activated with respect to a service needs to be exchanged in the process of generating the service and changing the parameter (e.g., the step S602 of FIG. 6).

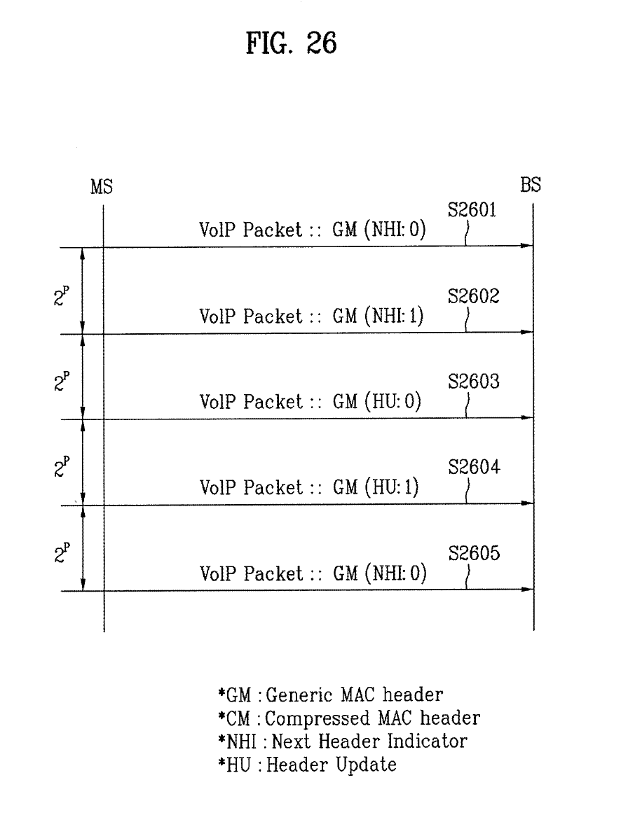

FIG. 26 is a view showing an example of a method of transmitting a VoIP packet using a compressed header according to an embodiment of the present invention.

First, the steps shown in FIG. 26 will be described in detail. First, the mobile station transmits the VoIP packet using the generic MAC header in a step S2601. At this time, the mobile station may set the NHI to 0 in a next packet in order to represent that the packet including the generic MAC header will be transmitted, and transmit the VoIP packet.

Thereafter, the mobile station transmits the packet using the generic MAC header at a frame corresponding to a next period (S2602). At this time, the mobile station may set the NHI to 1 in a packet transmitted in a next period and transmit the packet, in order to represent that the packet will be transmitted using the compressed header.

Thereafter, the mobile station may transmit the VoIP packet using the compressed header at a frame corresponding to a next period (S2603). At this time, as shown in FIG. 26, the mobile station may set the HU indicating whether or not the header is updated to 0 and transmit the packet, in order to transmit the VoIP packet using the compressed header even in the next period.

Then, the mobile station may transmit the packet using the compressed header at a frame corresponding to a next period (S2604). At this time, if the header needs to be updated, the mobile station may set the HU field to 1 and transmit the packet, in order to transmit the packet including the generic MAC header without compressing the header at the frame corresponding to the next period.

Then, the mobile station may transmit the packet using the generic MAC header at a frame corresponding to a next period (S2605). At this time, the mobile station may set the NHI field to 0 and transmit the packet, in order to transmit the packet including the generic MAC header at the frame corresponding to the next period.

Next, a method of transmitting a packet when a receiver cannot receive the packet in the method of transmitting the packet according to the present embodiment will be described.

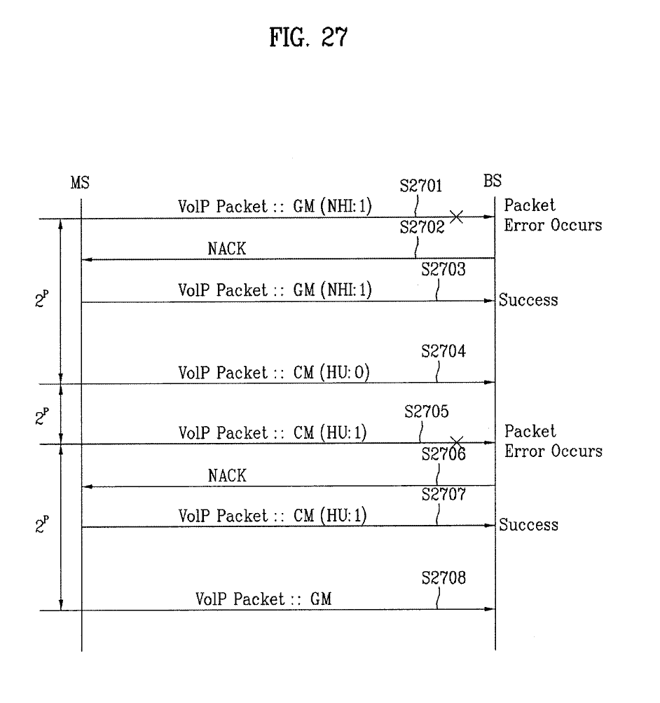

FIG. 27 is a view showing a method of transmitting a packet using a compressed header according to another embodiment of the present invention.

In more detail, the steps shown in FIG. 27 will be described. A transmitter (e.g., the mobile station (MS)) transmits a VoIP packet using a generic MAC header. At this time, the NHI may be set to 1, in order to the use the compressed header at a next frame (S2701).

In contrast, a receiver (e.g., the base station (BS)) may not receive the packet. At this time, the receiver may transmit a NACK to the transmitter in order to inform the transmitter of a packet reception error (S2702). When the transmitter receives the NACK, the transmitter may retransmit the same packet to the receiver (S2703).

If it is assumed that the receiver successfully receives the packet (not shown), the mobile station may transmit the VoIP packet using the compressed header in a next period (S2704). If the mobile station uses the generic MAC header for updating the header while the VoIP packet is transmitted using the compressed header, the HU of the compressed header is set to 1 and the packet is transmitted (S2705). If an error occurs in the process of receiving the transmitted packet by the receiver, the receiver may transmit the NACK to the transmitter (S2706) and the transmitter which receives the NACK may retransmit the same packet (S2707). If the packet transmission is successful, the mobile station may transmit the VoIP packet including the generic MAC header to the base station (S2708).

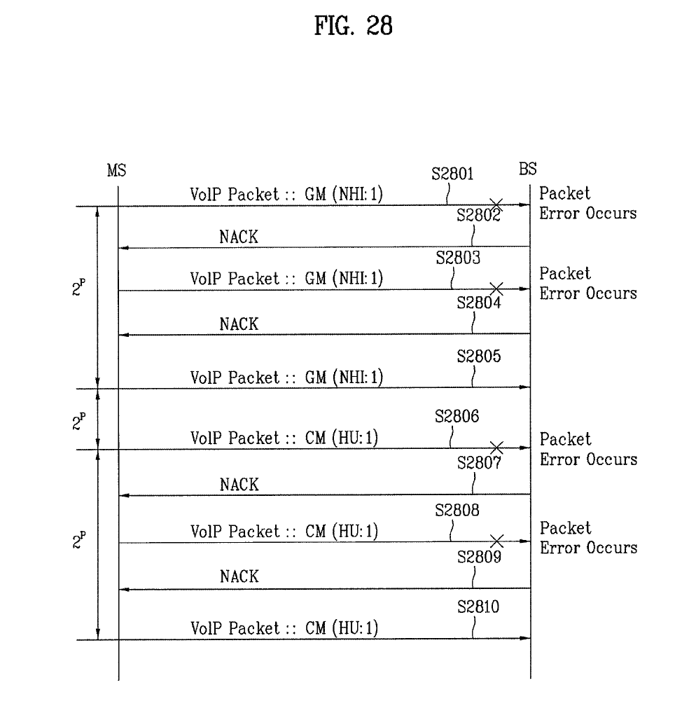

FIG. 28 is a view showing a method of transmitting a packet using a compressed header according to another embodiment of the present invention.

The transmitter (MS) transmits a VoIP packet using a generic MAC header. At this time, the NHI may be set to 1 in order to use the compressed header (S2801). If the receiver (BS) cannot receive the packet, the receiver transmits a NACK to the transmitter in order to inform the transmitter of a packet reception error (S2802). The transmitter which receives the NACK retransmits the same packet as the packet transmitted in the step S2801 to the receiver (S2803). In the example of FIG. 28, even in the packet retransmission, a reception error occurs in the receiver. If the reception error occurs, the receiver transmits the NACK to the transmitter in order to inform the transmitter of the packet reception error (S2804).

If the retransmission is continuously tried but the receiver cannot transmit the packet, the mobile station transmits the packet using the generic MAC header in the packet transmission of a next period, without using the compressed header (S2805). If the reception of the packet in which the NHI is set to 1 is successful, the transmitter may transmit the VoIP packet using the compressed header in a next period. In the example of FIG. 28, an example of setting the HU to 1 and transmitting the packet in order to use the generic MAC header at a next frame is shown (S2806).

If the reception of the receiver fails with respect to the packet transmission, the receiver transmits the NACK to the transmitter (S2807). The transmitter which receives the NACK retransmits the same packet as the packet transmitted in the step S2805, that is, the VoIP packet using the compressed header (S2808). When a reception error occurs, the receiver transmits the NACK to the transmitter in order to inform the transmitter of the packet reception error (S2809).

In the example of FIG. 28, the case where the packet retransmitted in the step S2809 cannot be properly transmitted is shown. If the retransmission is continuously tried but the receiver cannot properly transmit the packet, the mobile station transmits the packet using the compressed header even in the packet transmission of a next period (S2810).

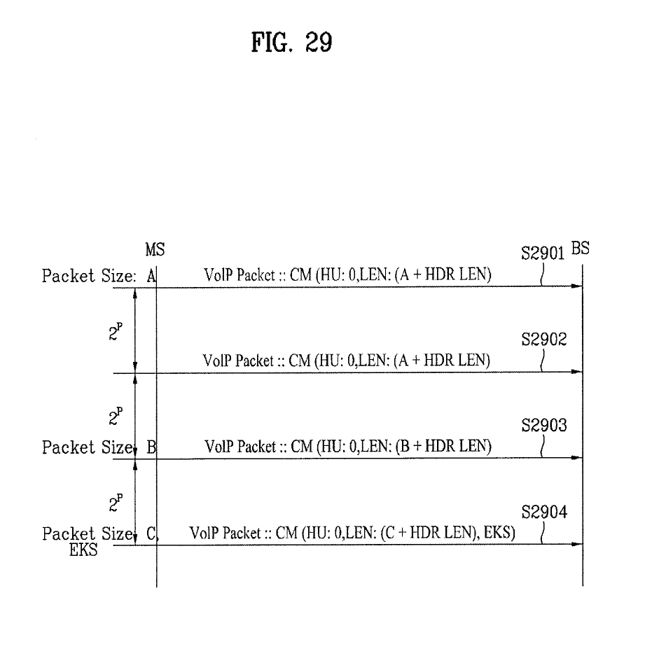

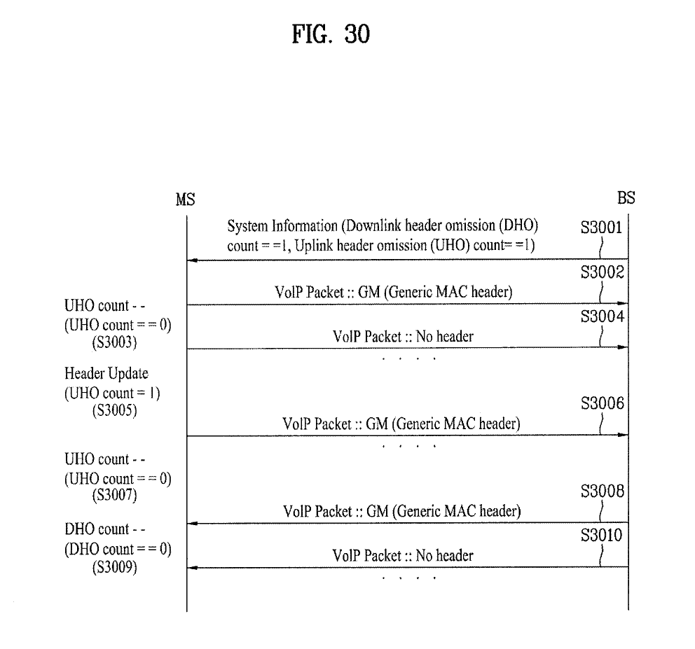

FIG. 29 is a view showing a method of transmitting a packet using a compressed header according to another embodiment of the present invention.

In the example of FIG. 29, the size of the packet transmitted by the mobile station is changed and the mobile station continuously transmits a VoIP packet using a compressed header.

In more detail, the mobile station transmits the VoIP packet having a size A using the compressed header (S2901 and 2902). If the size of the packet is changed to B, the mobile station transmits the VoIP packet using the compressed header of which the LEN value is changed (S2903). If the size C of the packet and the EKS are changed, the EKS value is added to the variable part of the frame, and the packet of which the LEN value is changed is transmitted (S2904).

That is, in the present embodiment, in the fields of the compressed header, the type and the header length (HDR LEN) may be decided according to the contents included in the header body.

A message (e.g., a signaling header, a unicast (e.g., a MAC management message)/broadcast (e.g., an UL-MAP IE/DL-MAP IE) management message, or a CQICH codeword) described in the above-described embodiments of the present invention may be transmitted and the header may be omitted or compressed. In addition, in the embodiments of the present invention, in order to decide a time point when the header is omitted or compressed, the mobile station and the base station exchange a predefined value before the packet transmission is started. This method will now be described.

First, the base station may inform the mobile station of a time point when the header is omitted or compressed using a system information message (e.g., UCD, DCD, or the like).

Second, when a service is generated, the base station and the mobile station may decide a time point when the header is omitted or compressed.

Finally, the mobile station and the base station may have a fixed value (global value) for omitting or compressing the header. That is, the system may fixedly set a count value for omitting the header.

For example, the value exchanged between the mobile station and the base station using any one of the three methods is 1, after the service is started, the mobile station and the base station may transmit a VoIP packet using a generic MAC header and transmit the packet in a state of omitting or compressing the MAC header in the transmission of a next packet. In the following embodiment, a method of, at the mobile station, acquiring a value for deciding a time point when the header is omitted will be described. However, the methods of the following embodiments may be applied to a method of compressing the header.

FIG. 30 is a view showing an embodiment of deciding a time point when a header is omitted by a system information message (e.g., DCD, UCD or the like).

That is, FIG. 30 shows a process of, at the base station, sending a downlink header omission (DHO) count and an uplink header omission (UHO) count to the mobile stations by a system information message.

In more detail, the base station sends the header omission counts (e.g., the DHO count and the UHO count) to the mobile stations by the system information message (S3001). The system information message corresponds to the DCD and the UCD of the 802.16d/e system. Accordingly, in the DHO count used in the present embodiment may be included in the DCD in the 802.16d/e system and the UHO count may be included in the UCD. In the present embodiment, an example in which the initial values of the UHO count and the DHO count are set to 1 is shown.

The mobile station generates a VoIP service, checks that the UHO count value is 1 before a VoIP packet is transmitted, and transmits the VoIP packet using a generic MAC header (S3002). The UHO count value is decreased by 1 together with the packet transmission using the generic MAC header (S3003). Thus, the UHO count value becomes 0.

Thereafter, since the UHO count value is 0 when the mobile station transmits a next VoIP packet, the mobile station transmits the VoIP packet without the header (S3004). Thereafter, if a header update event occurs in the mobile station, the mobile station sets an initial value of the UHO count value (that is, 1 in the present embodiment) (S3005). Since the UHO value is 1 at a frame corresponding to a next transmission period, the mobile station transmits the VoIP packet including the generic MAC header (S3006) and decreases the UHO count value by 1 if the reception is successful (S3007).

If the mobile station receives the VoIP packet from the base station, since the DHO count value is set to 1, it is determined that the VoIP packet including the generic MAC header is received (S3008). If the downlink VoIP packet is received, the mobile station decreases the DHO count value by 1 (S3009). Thereafter, if a next VoIP packet is received from the base station, since the DHO count value is set to 0, it is determined that the VoIP packet without the header is received (S3010).

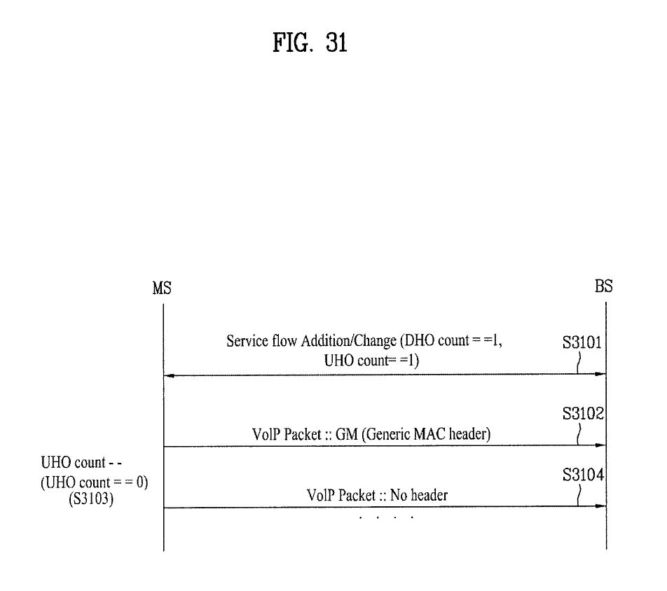

FIG. 31 is a view showing an embodiment of deciding a time point when a header is omitted when a service is generated.

That is, the mobile station and the base station may exchange and decide the DHO count and the UHO count in order to generate a service or change QoS parameters related to the service (S3101). In the present embodiment, similar to FIG. 30, it is assumed that the initial values of the DHO and the UHO are set to 1. A message for generating the service in a wideband wireless access system (IEEE 802.16 d/e system) is DSA-REQ/RSP and a message for changing the QoS parameters related to the service is a DSA-REQ/RSP.

Since the UHO count value is set to 1 at the time of the initial transmission, the mobile station transmits the VoIP packet including the generic MAC header (S3102). If the VoIP packet transmission is successful, the mobile station decreases the UHO count value by 1 (S3103). Since the UHO count value is set to 0 in a next transmission period, the VoIP packet without the header is transmitted (S3104).

Hereinafter, examples of downlink/uplink map information elements of the present invention will be described.

The information elements may be constituted by different information elements according to the used headers (header omission, header compression or the generic MAC header). All information indicating which header will be used may be included using one map information element (MAP IE).

Table 10 shows the map information elements representing whether or not the MAC header is omitted with respect to the downlink traffic.

TABLE 10

| Syntax | Size | Notes |
|---|---|---|
| DL_MAC_Header_Omission IE ( ) { | — | — |
| Extended DIUC | 4 bits | — |
| Length | 4 bits | — |
| CID | 16 bits | CID for VoIP |
| | | connection MS |
| HT | 1 bit | Header Type (HT) |
| | | 0b0: Generic MAC |
| | | header |
| | | 0b1: MAC header |
| | | omission |
| HM | 1 bit | Header Maintaining |
| | | (HM) |
| | | 0b0: This header type |
| | | is also applied to next |
| | | transmission |
| | | 0b1: This header type |
| | | is applied to only a |
| | | current frame |
| } | — | — |

That is, in the present embodiment, if the MAC header is desired to be omitted or updated (the generic MAC header is used) when the base station transmits downlink traffic to the mobile station or if a request for the MAC header omission or the header update is received from the mobile station with respect to the downlink traffic, the base station may transmit the downlink MAC header omission IE (DL_MAC Header Omission IE) shown in Table 10 to the mobile station in order to inform the mobile station whether or not the header is omitted with respect to the downlink traffic.

Meanwhile, Table 11 shows map information elements representing whether or not the MAC header is omitted with respect to the uplink traffic.

TABLE 11

| Syntax | Size | Notes |
|---|---|---|
| UL_MAC Header Omission IE ( ) { | — | — |
| Extended UIUC | 4 bits | — |
| Length | 4 bits | — |
| CID | 16 bits | CID for VoIP connection |
| | | MS |
| HT | 1 bit | Header Type (HT) |
| | | 0b0: Generic MAC |
| | | header |
| | | 0b1: MAC header |
| | | omission |
| HM | 1 bit | Header maintaining |
| | | (HM) |
| | | 0b0: This header type is |
| | | also applied to next |
| | | transmission |
| | | 0b1: This header type is |
| | | applied to only a |
| | | current frame |
| } | — | — |

That is, in the present embodiment, if the MAC header is desired to be omitted or updated (the generic MAC header is used) when the base station receives uplink traffic from the mobile station or if a request for the MAC header omission or the header update is received from the mobile station with respect to the uplink traffic, the base station may transmit the uplink MAC header omission IE (UL_MAC Header Omission IE) shown in Table 11 to the mobile station in order to inform the mobile station whether or not the header is omitted with respect to the uplink traffic.

Meanwhile, Table 12 shows map information elements representing whether or not the compressed MAC header is used with respect to the downlink traffic.

TABLE 12

| Syntax | Size | Notes |
|---|---|---|
| DL_MAC Header Compression IE | — | — |
| ( ) { | | |
| Extended DIUC | 4 bits | — |
| Length | 4 bits | — |
| CID | 16 bits | CID for VoIP connection |
| | | MS |
| HT | 1 bit | Header Type (HT) |
| | | 0b0: Generic MAC header |
| | | 0b1: MAC header |
| | | compression |
| HM | 1 bit | Header |
| | | maintaining (HM) |
| | | 0b0: This header type is |
| | | also applied to next |
| | | transmission |
| | | 0b1: This header type is |
| | | applied to only a current |
| | | frame |
| } | — | — |

That is, in the present embodiment, if the compressed MAC header or the generic MAC header is desired to be used when the base station transmits downlink traffic to the mobile station or if a request for the use of the compressed MAC header is received from the mobile station with respect to the downlink traffic, the base station may transmit the downlink MAC header compression IE (DL_MAC Header Compression IE) shown in Table 12 to the mobile station in order to inform the mobile station whether or not the compressed MAC header is used with respect to the downlink traffic.

Meanwhile, Table 13 shows map information elements representing whether or not the compressed MAC header is used with respect to the uplink traffic.

TABLE 13

| Syntax | Size | Notes |
|---|---|---|
| UL_MAC Header Compression IE | — | — |
| ( ) { | | |
| Extended UIUC | 4 bits | — |
| Length | 4 bits | — |
| CID | 16 bits | CID for VoIP connection |
| | | MS |
| HT | 1 bit | Header Type (HT) |
| | | 0b0: Generic MAC header |
| | | 0b1: MAC header |
| | | compression |
| HM | 1 bit | Header Maintaining (HM) |
| | | 0b0: This header type is |
| | | also applied to next |
| | | transmission |
| | | 0b1: This header type is |
| | | applied to only a current |
| | | frame |
| } | — | — |

That is, in the present embodiment, if the compressed MAC header or the generic MAC header is desired to be used when the base station receives uplink traffic from the mobile station or if a request for the use of the compressed MAC header is received from the mobile station with respect to the uplink traffic, the base station may transmit the uplink MAC header compression IE (UL_MAC Header Compression IE) shown in Table 13 to the mobile station in order to inform the mobile station whether or not the compressed MAC header is used with respect to the uplink traffic.

In one embodiment of the present invention, when the generic MAC header is desired to be used in order to update the header, a header omission information element or a header compression information element may be used.

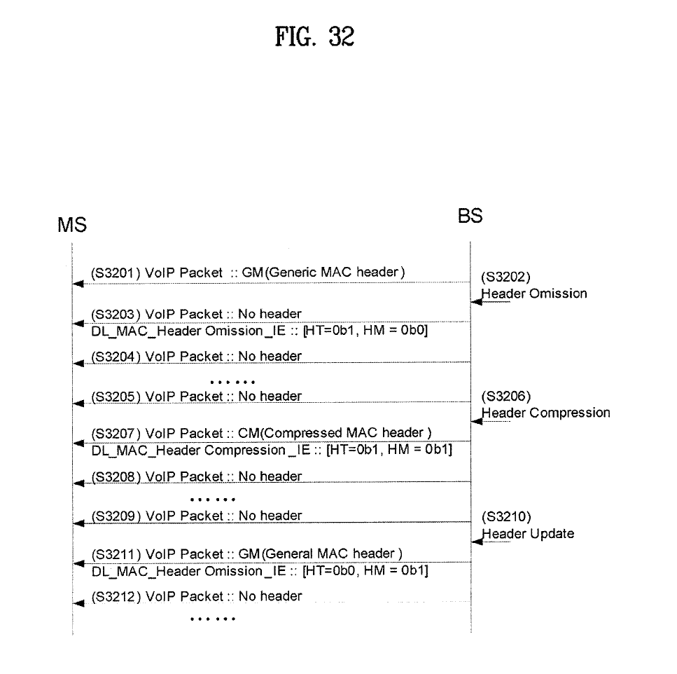

FIG. 32 is a view showing an embodiment of adjusting downlink traffic using map information elements suggested in the present invention.

In the present embodiment, if the base station wants to omit the header (S3202) while a downlink VoIP packet is transmitted using a generic MAC header (S3201), the base station transmits a DL_MAC_header Omission IE, in which a HT is set to 0b1 (header omission) and a HM is set to 0b0 (a current header type is maintained even in next transmission), to the mobile station in order to inform the mobile station of the header omission (S3203). When a compressed header is desired to be used (S3206) while the packet without the header is transmitted (S3204 to S3205), the base station transmits a downlink MAC header compression IE, in which a HT is set to 0b1 (header compression) and a HM is set to 0b1 (the header type is applied to only a current frame), to the mobile station (S3207). When the base station wants to use the generic MAC header (S3210) while the packet without the header is transmitted (S3208 to S3209), the base station transmits a downlink MAC header compression IE, in which a HT is set to 0b0 (the generic header is used) and a HM is set to 0b1 (the header type is applied to only a current frame), to the mobile station (S3211).

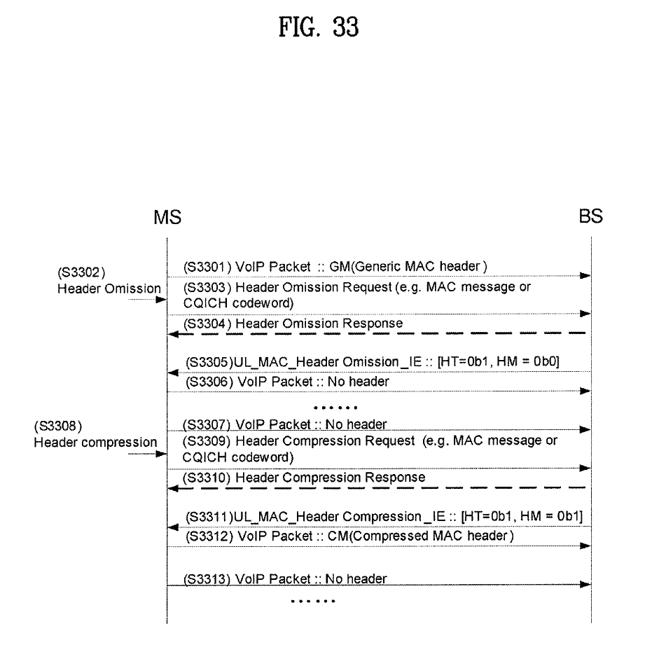

FIG. 33 is a view showing an embodiment of adjusting downlink traffic using map information elements suggested in the present invention.

FIG. 33 shows the case where a header omission/compression event is generated in the mobile station. If a header use event is generated in the base station, map information elements (UL_MAC_Header Omission IE/UL_MAC_Header Compression IE) are transmitted to the mobile station such that the mobile station may be informed of the header use event.

In more detail, in the present embodiment, if a header omission event is generated in the mobile station and the header is desired to be omitted (S3302) while the mobile station transmits an uplink VoIP packet using a generic MAC header (S3301), the mobile station transmits a header omission request signal to the base station in order to inform the base station of the header omission (S3303). The mobile station may use various signals such as a MAC management message, a MAC header and a CQICH codeword, for the header omission request. The base station may immediately respond to the header omission request (S3304). The base station may transmit a header omission map information element (UL_MAC_Header Omission IE) to the mobile station and respond to the request (S3305). The mobile station which receives the header omission map information element (UL_MAC_Header Omission IE) properly omits the header according to the set parameters and transmits the packet (S3306 to S3307).

When a header compression event is generated in the mobile station and the compressed header is desired to be used (S3308), the mobile station transmits a header compression request signal to the base station (S3309). At this time, the mobile station may use various signals such as a MAC management message, a MAC header and a CQICH codeword, for the header compression request. The base station immediately responds to the header compression request (S3310). The base station may transmit a header compression map information element (UL_MAC_Header Compression IE) to the mobile station and respond to the request (S3311). The mobile station which receives the header compression map information element (UL_MAC_Header Compression IE) properly compresses the header according to the set parameters and transmits the packet (S3312).

In one embodiment of the present invention, when mobile station transmits a request signal to the base station in order to update the header or use the compressed header, information to be updated may be included in the request signal. For example, when the mobile station wants to transmit a header compression request signal, compression header type information may be included in a header compression request signal.

Tables 14 and 15 show examples of defining information elements (IEs) in which the header omission and the compressed header can be used by one MAP IE.

TABLE 14

| Syntax | Size | Notes |
|---|---|---|
| DL_MAC Header Optimization IE | — | — |
| ( ) { | | |
| Extended DIUC | 4 bits | — |
| Length | 4 bits | — |
| CID | 16 bits | CID for VoIP connection |
| | | MS |
| HT | 2 bits | Header Type (HT) |
| | | 0b00: Generic MAC header |
| | | 0b01: MAC header |
| | | omission |
| | | 0b10: MAC header |
| | | compression |
| | | 0b11: Reserved |
| HM | 1 bit | Header Maintaining (HM) |
| | | 0b0: This header type is |
| | | also applied to next |
| | | transmission |
| | | 0b1: This header type is |
| | | applied to only a current |
| | | frame |
| } | — | — |

TABLE 15

| Syntax | Size | Notes |
|---|---|---|
| UL_MAC Header Optimization IE | — | — |
| ( ) { | | |
| Extended UIUC | 4 bits | — |
| Length | 4 bits | — |
| CID | 16 bits | CID for VoIP connection |
| | | MS |
| HT | 2 bits | Header Type (HT) |
| | | 0b00: Generic MAC header |
| | | 0b01: MAC header |
| | | omission |
| | | 0b10: MAC header |
| | | compression |
| | | 0b11: Reserved |
| HM | 1 bit | Header Maintaining (HM) |
| | | 0b0: This header type is |
| | | also applied to next |
| | | transmission |
| | | 0b1: This header type is |
| | | applied to only |
| | | a current frame |
| } | — | — |

In more detail, Table 14 shows a downlink MAC header optimization IE (DL_MAC header optimization IE) representing which MAC header is used with respect to downlink traffic.

Table 15 shows an uplink MAC header optimization IE (UL_MAC header optimization IE) representing which MAC header is used with respect to uplink traffic.

Information included in the map information elements suggested in the present invention may be included in a new map information element (DL/UL MAP IE), in the existing map information elements, or in other map information elements which are newly defined according to the embodiments of the present invention. For example, HT and HM fields may be included in a persistent VoIP resource allocation map information element (e.g., a DL_Persistent allocation IE or an UL_Persistent allocation IE) so as to inform the mobile station whether or not the MAC header is present or the compression is performed.

In the above-described embodiments of the present invention, a signaling method which can be used for informing or instructing the header omission/compression or the header update will be described.

First, a generic MAC header which is corrected according to one embodiment of the present invention in association with FIG. 5 may be used. Such a generic MAC header is available in both the base station and the mobile station.

Next, a MAC signaling header according to one embodiment of the present invention in association with FIG. 13 may be used. Such a MAC signaling header is available in the mobile station when a specific event is generated in the mobile station.

An extended subheader according to one embodiment of the present invention in association with Tables 3 to 5 may be used. Such an extended subheader is available in the base station when a specific event is generated in the base station.

Next, a MAC management message such as the header omission/compression/update request/response message of the above-described embodiments may be used. This may be used in an embodiment in which the mobile station transmits a request message when the mobile station generates a specific event, and the base station transmits a response message in response thereto.

In addition, in the embodiment associated with FIG. 7, as described above, a specific CQICH codeword which is previously decided between the base station and the mobile station may be used for the header omission/compression/update. The specific CQICH codeword may be used for transmitting the specific CQICH codeword and informing the base station of the specific CQICH codeword when an event such as header omission/compression/update is generated.

Finally, the MAP IE (e.g., UL-MAP IE or DL-MAP IE) may be used in association with Tables 10 to 15. This may be used as a response for a request message of the mobile station or may be used for informing the base station of an event when a specific event is generated in the mobile station or the base station.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

As described above, according to the embodiments of the present invention, since a packet including a compressed header is transmitted by omitting a header including the same information as a header of a packet which is previously transmitted or information overlapping with the header of the packet which is previously transmitted, it is possible to solve header overhead.

In particular, the packet transmitting method is further efficient in a VoIP packet transmitting method which is significantly influenced by the header overhead. In a detailed embodiment of the present invention, for header omission or compression at the time of the transmission of the VoIP packet, a detailed method of exchanging information between a base station and a mobile station is provided such that those skilled in the art readily embody the packet transmitting method according to the present invention.

Even when the header compression or the omission is supported as described above, a detailed method which copes with the case where a header is updated in the base station or the mobile station even in a specific situation or the case where packet transmission fails is provided so as to actively cope with various situations.

1. A method of transmitting a packet, the method comprising:
transmitting a first packet including a first header; and
transmitting a second packet after the first packet is transmitted,
wherein, if a second header of the second packet includes the same information as information included in the first header, the step of transmitting the second packet is performed as:
transmitting the second packet in a state of omitting the second header, or
transmitting the second packet in a state of compressing the second header by omitting certain amount of information of the second header, the certain amount of information is the same information included in the first header.

2. The method according to claim 1, wherein:
the first packet and the second packet are Voice over Internet Protocol (VoIP) packets, and
resources are allocated to the VoIP packets by a persistent resource allocation method or a group resource allocation method.

3. The method according to claim 1, wherein the first header includes an indicator indicating one of whether or not the second header is omitted, and whether or not the second header is compressed.

4. The method according to claim 1, further comprises:
transmitting a header update request message; and
receiving a header update response message for the header update request message,
when an update of header information of a subsequent packet subsequent to a specific packet is required after the specific packet is transmitted.

5. The method according to claim 4, further comprising:
transmitting an updated header, wherein the updated header and the subsequent packet subsequent to the specific packet are transmitted through a same region.

6. The method according to claim 4, further comprising:
transmitting an updated header, wherein the updated header and the subsequent packet subsequent to the specific packet are transmitted through different regions.

7. The method according to claim 4, wherein the header update request message includes header information which requires the update.

8. The method according to claim 1, wherein, after a specific packet is transmitted, if an update of header information of a subsequent packet subsequent to the specific packet is required, the method further comprises:
transmitting a channel quality indicator channel (CQICH) codeword which is previously allocated for the update of the header; and
transmitting a third packet including a third header including header information which requires the update.

9. The method according to claim 1, wherein, after a specific packet is transmitted, if an event corresponding to any one of an update of header information of a subsequent packet subsequent to the specific packet, a header omission or a header compression occurred, the method further comprises:
transmitting a MAP information element (MAP IE) for informing the event; and
performing any one of the update of the header information of the subsequent packet, the header omission or the header compression according to the event.

10. The method according to claim 9, wherein the MAP IE represents all of whether or not the update of the header information of the subsequent packet is required, whether or not the header is omitted, and whether or not the header is compressed.

11. The method according to claim 1, further comprising:
retransmitting the second packet without omitting or compressing the second header, when a NACK is received from a receiver with respect to the transmission of the second packet by a predetermined number of times.

12. The method according to claim 1, further comprising:
at a mobile station, negotiating with a base station whether at least one of a header omission function and a header compression function is supported; and
at the mobile station, negotiating with the base station whether at least one of the header omission function and the header compression function is activated.

13. The method according to claim 1, wherein:
if the second header is a compressed header, the second header includes a fixed part and a variable part; and
the variable part includes information which varies according to a type field of the second header.

14. The method according to claim 13, wherein the variable part includes information which requires the update of the header when the second packet is transmitted.

15. The method according to claim 1, wherein the information which is omitted as the same information of the second header as the information included in the first header includes at least one of a connection ID (CID) and the length of the packet.

16. A method of transmitting an uplink packet of a mobile station, the method comprising:
(a) receiving first indication information indicating header omission or header compression from a base station if a header omission event or a header compression event occurred in the mobile station or the base station; and
(b) omitting or compressing a second header of a second packet subsequent to the reception of the first indication information, according to the first indication information, and transmitting the second packet to the base station,
wherein the omission or the compression of the second header is performed with respect to information overlapping with a first header of a first packet which is transmitted before the second packet.

17. The method according to claim 16, wherein, when the header update event occurred in the base station or the mobile station, the method further comprises:
(c) receiving second indication information indicating the header update from the base station; and
(d) updating a third header of a third packet subsequent to the reception of the second indication information, according to the second indication information, and transmitting the third packet to the base station.

18. The method according to claim 16, further comprising, if the header omission event, the header compression event or the header update event occurred in the mobile station in the step (a) or (c), reporting the generation of the event in the mobile station to the base station.

19. The method according to claim 16, wherein the first indication information indicating the header omission or the header compression and the second indication information indicating the header update is received using at least one of a MAP information element (IE), a generic MAC header, a MAC signaling header, an extended subheader and a MAC management message.

20. The method according to claim 18, wherein, in the reporting of the generation of the event, information on the generation of the event is reported using at least one of an MAP information element (IE), a generic MAC header, a MAC signaling header, an extended subheader, a specific channel quality indicator channel (CQICH) codeword and a MAC management message.

21. The method according to claim 19, wherein the MAP IE includes:
information indicating whether or not the header of the second packet or the third packet transmitted just after the MAP IE is received, is omitted, or compressed; and
information indicating whether or not a header format of a fourth packet subsequent to the second packet or the third packet is equal to that of the second packet or the third packet.

22. The method according to claim 21, wherein the MAP IE represents whether or not the header of the second packet or the third packet transmitted just after the MAP IE is received, is omitted, compressed or updated.

23. A method of transmitting a downlink packet by a base station, the method comprising:
(a) omitting or compressing a second header of a second packet subsequent to a generation of a header omission event or a header compression event in the base station or a mobile station, and transmitting the second packet,
wherein the omission or the compression of the second header is performed with respect to information overlapping with a first header of a first packet which is transmitted before the second packet.

24. The method according to claim 23, wherein, when a header update event occurred in the base station or the mobile station, the method further comprises:
(b) updating a third header of a third packet subsequent to the generation of the header update event, and transmitting the third packet to the mobile station.

25. The method according to claim 23, wherein, if the header omission event, the header compression event or the header update event occurred in the mobile station in the step (a) or (b), the method further comprises:
at the base station, receiving information on the generation of the event from the mobile station.

26. The method according to claim 25, wherein, in the receiving of the information on the generation of the event, the information on the generation of the event is received using at least one of an MAP information element (IE), a generic MAC header, a MAC signaling header, an extended subheader, a specific channel quality indicator channel (CQICH) codeword and a MAC management message.

27. The method according to claim 26, wherein the MAP IE includes:
information indicating whether or not the header of the second packet or the third packet transmitted just after the MAP IE is received is omitted or compressed; and
information indicating whether or not a header format of a fourth packet subsequent to the second packet or the third packet is equal to that of the second packet or the third packet.

28. The method according to claim 27, wherein the MAP IE represents all of whether or not the header of the second packet or the third packet transmitted just after the MAP IE is received is omitted, compressed and updated.
